(19) United States
(12) Patent Application Publication
(10) Pub. No.: US 2026/0323134 A1
(43) Pub. Date: Oct. 15, 2026

(54) METHOD FOR DISPLAYING PLAYER INFORMATION ON A EXERCISE VIDEO

(71) Applicant: FITOGETHER INC., Seoul (KR)

(72) Inventors: Jaechan LEE, Yongin-si (KR); Changjo KIM, Suwon-si (KR)

(73) Assignee: FITOGETHER INC., Seoul (KR)

(21) Appl. No.: 19/106,885

(22) PCT Filed: Dec. 5, 2023
(86) PCT No.: PCT/KR2023/019840

§ 371 Date: Feb. 26, 2025

(30) Foreign Application Priority Data
Dec. 5, 2023 (KR) 10-2023-0173941
Dec. 5, 2023 (KR) 10-2023-0173944

(51) Int. Cl. H04N 21/81; H04N 21/431

(52) U.S. Cl. CPC H04N 21/8133; H04N 21/4316

(57) ABSTRACT

Provided are a method for displaying player information on a sports video. The method comprises acquiring a captured video for a sports event over a target time interval; acquiring sensor-based locational information over the target time interval for each of the players participating in the sports event; determining the corresponding position in the captured video corresponding to the sensor-based locational information for each of the players; and displaying information on each of the players at each of the corresponding positions.

### TECHNICAL FIELD

The present disclosure generally relates to a sports video and supplementary information and, more specifically but not exclusively, to a technique for displaying player information on a sports video.

### BACKGROUND ART

The importance of sports analysis is gradually increasing due to the explosive growth of the sports industry market and the development of sports science. Amid this trend, Electronic Performance Tracking Systems (EPTS) that track sports players during games or training sessions have been introduced one after another, particularly in major sports such as soccer. In EPTS, the position and movement of a sports player are used as important basic data for providing various supplementary information; consequently, various efforts have been made to facilitate the acquisition of tracking information on the positions of sports players and to improve its accuracy.

In relation to the description above, methods for determining the position of an object based on the characteristics of signals measured by sensors corresponding to the object, such as the Global Positioning System (GPS), have been widely used. Recently, advances in image analysis technology have enabled methods for calculating the position of an object from images containing the object captured by a camera. However, image-based and sensor-based position determination methods have their own limitations, which have led to various studies aimed at overcoming the respective limitations.

Meanwhile, sports analysis and information provision have evolved into two main fields comprising the traditional video analysis, which is based on images and wearable analysis, which relies on the information acquired from sensors such as wearable devices. However, recent efforts have been widely made to integrate image information of sports scenes, event information related to the occurrences in the corresponding sports game, and tracking information derived from collection and analysis of movements of sports players. In other words, there is a growing demand for displaying player information alongside images of a sports game.

### DISCLOSURE

### Technical Problem

In what follows, a summary of specific embodiments of the present disclosure is provided. The aspects presented in the summary below are merely intended to provide a brief overview of specific embodiments and should not be construed as limiting the scope of the present disclosure. Accordingly, it is to be understood that the present disclosure may further include various aspects not explicitly set forth below.

The present disclosure and the concepts thereof disclosed below provide methods, devices, and computer-readable storage media for displaying player information on a sports video.

One object of the present disclosure is to provide a method for efficiently displaying player information on the captured video without incurring high costs for image analysis by acquiring locational information of each player participating in a sports event based on sensors and displaying at least part of the acquired locational information and supplementary information derived from analysis at the corresponding positions in the captured video related to the sports event.

One object of the present disclosure is to provide a device for efficiently displaying player information on the captured video without incurring high costs for image analysis by acquiring locational information of each player participating in a sports event based on sensors and displaying at least part of the acquired locational information and supplementary information derived from analysis at the corresponding positions in the captured video related to the sports event.

However, the technical problem to be solved by the present disclosure is not limited to the above but may be extended to other various problems belonging to the scope not departing from the technical principles and domain of the present disclosure.

### Technical Solution

Embodiments include methods, devices, and computer-readable storage media for displaying player information on a sports video.

According to one embodiment, a method for displaying player information on a sports video is provided, which is performed by a computing device. The method may comprise acquiring a captured video for a sports event over a target time interval; acquiring sensor-based locational information over the target time interval for each of the players participating in the sports event; determining the corresponding position in the captured video corresponding to the sensor-based locational information for each of the players; and displaying information on each of the players at each of the corresponding positions.

According to another embodiment, a device for displaying player information on a sports video is provided. The device comprises a processor; and a memory, wherein the processor is configured to acquire a captured video for a sports event over a target time interval; acquire sensor-based locational information over the target time interval for each of the players participating in the sports event; determine the corresponding position in the captured video corresponding to the sensor-based locational information for each of the players; and display information on each of the players at each of the corresponding positions.

According to yet another embodiment, a computer-readable storage medium including commands that may be executed by a processor is provided. The commands are intended to display player information on a sports video, wherein the commands, by being executed by the processor, may be configured to instruct the processor to acquire a captured video for a sports event over a target time interval; acquire sensor-based locational information over the target time interval for each of the players participating in the sports event; determine the corresponding position in the captured video corresponding to the sensor-based locational information for each of the players; and display information on each of the players at each of the corresponding positions.

Other exemplary embodiments, different from the exemplary embodiments given above, will be described or become apparent through detailed descriptions to be given below with respect to the exemplary embodiments to be read in conjunction with accompanying drawings.

### Advantageous Effects

The present disclosure may provide the following effects. However, since it is not meant that a specific embodiment has to provide all of or only the following effects, the technical scope of the present disclosure should not be regarded as being limited by the specific embodiment.

According to an embodiment of the present disclosure, a method may be provided for acquiring sensor-based locational information of each of the players participating in a sports event and displaying at least part of the acquired locational information and supplementary information derived from analysis at the corresponding position in the captured video related to the corresponding sports event.

Accordingly, it is possible to display the locational information and/or supplementary information of each player at the exact corresponding position in the captured video while avoiding the high overall costs required for acquiring locational information through image analysis and achieving a simpler implementation with lower computational complexity.

The foregoing description of the present disclosure does not constitute a complete list of all aspects of the present disclosure. The present disclosure should be understood to include not only the matters summarized above but also all possible implementations of methods, devices, and systems derived from appropriate combinations of the various aspects disclosed in the detailed descriptions and appended claims provided below.

### BRIEF DESCRIPTION OF DRAWINGS

FIG. 1 illustrates acquisition of image-based locational information.

FIG. 2 illustrates acquisition of sensor-based locational information.

FIG. 3 illustrates an example of a state in which an undetected object exists.

FIG. 4 illustrates an example of a state in which a falsely detected object exists.

FIG. 5 illustrates object matching between frames in a video containing a plurality of objects.

FIG. 6 illustrates a comparison between a GPS method and an OTS method.

FIG. 7 illustrates an exemplary system in which a method for displaying player information according to one embodiment of the present disclosure may be performed.

FIG. 8 is a block diagram of a sensor device that may be used for obtaining sensor-based locational information according to one embodiment of the present disclosure.

FIG. 9 is a block diagram of a server according to one embodiment of the present disclosure.

FIG. 10 is a conceptual diagram of a method for displaying player information on a sports video according to one embodiment of the present disclosure.

FIG. 11 is an exemplary diagram of a state in which player information is displayed on a sports video according to one embodiment of the present disclosure.

FIG. 12 provides a detailed description of the player information displayed in FIG. 11.

FIG. 13 is a schematic flowchart of a method for displaying player information on a sports video according to one embodiment of the present disclosure.

FIG. 14 is a detailed flowchart illustrating the determining of the corresponding position of FIG. 13.

FIG. 15 is a second detailed flowchart illustrating the determining of the corresponding position of FIG. 13.

FIG. 16 is an exemplary diagram for a display screen of a captured video and sensor-based locational information according to one embodiment of the present disclosure.

FIG. 17 is an exemplary diagram of a screen for inputting pitch corners by a user.

FIG. 18 illustrates conversion between pixel coordinate system and pitch coordinate system.

FIG. 19 is an example of a position input request screen for a first player.

FIG. 20 is an example of a position input screen for the first player by the user.

FIG. 21 is an example of a position input screen for the second player by the user.

FIG. 22 is an example of a position input screen for the third player by the user.

FIG. 23 is an example of a position input result for a plurality of players.

FIG. 24 illustrates conversion between a pixel coordinate system and a global coordinate system.

FIG. 25 illustrates a procedure for receiving a batch of change values for the corresponding positions of a plurality of players from the user.

FIG. 26 shows an information display state according to the batch change result of FIG. 25.

FIG. 27 illustrates a procedure for receiving an individual change value for the corresponding position of a specific player among a plurality of players from the user.

FIG. 28 shows an information display state according to the individual change result of FIG. 27.

FIG. 29 is a block diagram showing a GNSS module configuration for time synchronization between a captured video and sensor-based locational information.

FIG. 30 is a block diagram showing an exemplary configuration of a computing system in which a method according to one embodiment of the present disclosure may be performed.

### MODE FOR INVENTION

Since the present disclosure may be modified in various ways and may provide various embodiments, specific embodiments will be depicted in the appended drawings and described in detail with reference to the drawings.

However, it should be understood that the specific embodiments are not intended to limit the gist of the present disclosure to the specific embodiments; rather, it should be understood that the specific embodiments include all of the modifications, equivalents, and/or alternatives of the embodiments of the present disclosure.

The terms such as first and second are introduced to describe various elements, but the elements should not be limited by the terms. The terms are used only for the purpose of distinguishing one element from the other elements. For example, a first element may be called a second element without leaving the technical scope of the present disclosure, and similarly, the second element may be called the first element. The term and/or includes any one of a combination of a plurality of related disclosed elements or a plurality of related disclosed elements.

If an element is said to be “connected” or “attached” to a different element, the former may be connected or attached directly to the different element, but another element may be present between the two elements. On the other hand, if an element is said to be “directly connected” or “directly attached” to a different element, it should be understood that there is no other element between the two elements.

Terms used in this document are intended only for describing a specific embodiment and are not intended to limit the technical scope of the present disclosure. A singular expression should be understood to indicate a plural expression unless otherwise explicitly stated. The term “include” or “have” is used to indicate existence of an embodied feature, number, step, operation, element, component, or a combination thereof; and should not be understood to preclude the existence or possibility of adding one or more other features, numbers, steps, operations, elements, components, or a combination thereof.

Unless defined otherwise, all the terms used in the present disclosure, including technical or scientific terms, provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

In what follows, with reference to appended drawings, preferred embodiments of the present disclosure will be described in more detail. In describing the present disclosure, to help overall understanding, the same reference symbols are used for the same elements in the drawings, and repeated descriptions of the same elements will be omitted.

Since the embodiments described in the present document are intended to clearly explain the technical principles of the present disclosure to those skilled in the art to which the present disclosure belongs, it should be understood that the present disclosure is not limited to the embodiments described in this document, and the scope of the present disclosure should be interpreted to include modified or altered examples that do not depart from the technical principles of the present disclosure.

The terms used in the present disclosure have been selected from commonly used and widely accepted terms that best describe the technical field to which the present disclosure belongs; however, it should be noted that the meanings of terms may vary depending on the intention of those persons skilled in the technical field to which the present disclosure belongs, precedents, or emergence of new technologies. Meanwhile, different from the above, when some terms may be defined arbitrarily by the applicant, definitions of the terms will be provided in the corresponding description of the present disclosure. Therefore, the terms used in the present disclosure should be interpreted not simply by their apparent name but based on their meaning and context throughout the present disclosure.

The appended drawings of the present disclosure are provided to facilitate the description of the present disclosure, and the shapes illustrated therein may be exaggerated or simplified as necessary for better understanding of the present disclosure; therefore, it should be understood that the present disclosure is not limited by the appended drawings.

In describing the present disclosure, if it is determined that a detailed description of known configurations or functions related to the present disclosure unnecessarily obscure the gist of the present disclosure, the detailed description thereof will be omitted.

A method for displaying player information on a sports video according to one aspect of the present disclosure may be performed by a computing device, and the method may comprise acquiring a captured video for a sports event over a target time interval; acquiring sensor-based locational information over the target time interval for each of the players participating in the sports event; determining the corresponding position in the captured video corresponding to the sensor-based locational information for each of the players; and displaying information on each of the players at each of the corresponding positions.

According to one aspect, the sensor-based locational information may be the locational information acquired based on the Global Navigation Satellite System (GNSS).

According to one aspect, the player information may include at least one of the following: personal information of the player; sensor-based locational information of the player; speed of the player; and trajectory of the player over a predetermined time interval.

According to one aspect, the determining of the corresponding position may include displaying at least part of the captured video and the sensor-based locational information; receiving information on the positions of pitch corners within the captured video from a user; receiving information on the position of a first player within the captured video from the user; and receiving information on the position of a second player within the captured video from the user.

According to one aspect, the first player and the second player may correspond to the players, among a plurality of players included in the captured video, who are separated from each other by the greatest distance.

According to one aspect, the receiving of the locational information of the first player in the captured video and the receiving of the locational information of the second player in the captured video may be performed on different frames among a plurality of frames included in the captured video.

According to one aspect, the locational information of the first player in the captured video and the locational information of the second player in the captured video may correspond to the locational information of a single player in different frames.

According to one aspect, the receiving of the information on the position of the first player in the captured video may be performed in response to the determination that the sensor-based locational information on the first player has been acquired in the RTK-GPS mode.

According to one aspect, the determining of the corresponding position may further include, after the receiving of the information on the position of the second player in the captured video from the user, calculating the corresponding positions of a plurality of players based on information on the positions of the pitch corners, the first player, and the second player in the captured video; and receiving, from the user, a batch of change values for the calculated corresponding positions of the plurality of players.

According to one aspect, the information on the positions of the pitch corners in the captured video may be used for conversion between the pixel coordinate system expressing positions in the captured video and the pitch coordinate system expressing positions in the pitch where a sports event is performed.

According to one aspect, the information on the position of the first player in the captured video and the information on the position of the second player in the captured video may be used for conversion between the global coordinate system used by the sensor-based locational information and the pixel coordinate system expressing positions in the captured video.

According to one aspect, the determining of the corresponding position may perform conversion between the global coordinate system used by the sensor-based locational information and the pitch coordinate system expressing positions in the pitch where a sports event is performed, based on the information on the positions of the pitch corners in the captured video, information on the positions of the first player in the captured video, and information on the positions of the second player in the captured video.

According to one aspect, the displaying of at least part of the captured video and the sensor-based locational information may be configured to display a relative positional relationship of sensor-based locational information with respect to a representative value of a plurality of sensor-based locational information; identification information of a sensor device corresponding to each sensor-based locational information; and a position input request message for the first player or the second player.

According to one aspect, the first player and the second player may be determined based on the distances among a plurality of pieces of sensor-based locational information.

According to one aspect, after the receiving of the batch of change values from the user, receiving a change value for the corresponding position of one of the plurality of players from the user may further be included.

According to one aspect, the captured video may be captured by a camera having a first GNSS module, and the sensor-based locational information may be determined based on a second GNSS module of the same type as the first GNSS module.

According to one aspect, the determining of the corresponding position may be configured to match each frame of the captured video with acquisition time of the sensor-based locational information based on time information of the first GNSS module and the second GNSS module.

A device for displaying player information on a sports video according to one aspect of the present disclosure comprises a processor; and a memory, wherein the processor is configured to acquire a captured video for a sports event over a target time interval; acquire sensor-based locational information over the target time interval for each of the players participating in the sports event; determine the corresponding position in the captured video corresponding to the sensor-based locational information for each of the players; and display information on each of the players at each of the corresponding positions.

A computer-readable storage medium including commands executable by a processor according to one aspect of the present disclosure, wherein the commands are intended to display player information on a sports video and, by being executed by the processor, are configured to instruct the processor to acquire a captured video for a sports event over a target time interval; acquire sensor-based locational information over the target time interval for each of the players participating in the sports event; determine the corresponding position in the captured video corresponding to the sensor-based locational information for each of the players; and display information on each of the players at each of the corresponding positions.

### Acquisition of Locational Information

As described above, the importance of sports analysis is gradually increasing due to the explosive growth of the sports industry market and the development of sports science. Amid this trend, Electronic Performance Tracking Systems (EPTS) that track sports players during games or training sessions have been introduced one after another, particularly in major sports such as soccer. In EPTS, the position and movement of a sports player are used as important basic data for providing various supplementary information; consequently, various efforts have been made to facilitate the acquisition of tracking information on the positions of sports players and to improve its accuracy.

More specifically, just as in many other industries, data science has begun to be used as a crucial tool in the sports industry, where the primary types of data utilized in sports may be classified into event data and tracking data. Event data may include information related to ball-related events occurring during a sports match, while tracking data may include collected positional information of each player over specific time intervals.

In dynamic team sports such as soccer, basketball, or ice hockey, player tracking data may provide rich information that may be overlooked when event data alone are used, such as interactions between players and off-the-ball movements. For example, in a soccer game, various applications may be utilized based on the player tracking data, including formation and role estimation, space control analysis, play style identification, and foul prediction.

Recently, different types of tracking systems, such as the Global Positioning System (GPS), Local Positioning System (LPS), or Optical Tracking System (OTS) based on a plurality of cameras, have been proposed and successfully adopted for soccer games to obtain the tracking data.

GPS has the advantages of lower cost and easy installation compared to other methods but is known to be more susceptible to environmental factors such as weather and stadium conditions. On the other hand, OTS may provide more accurate tracking information if a sufficiently large number of high-resolution cameras are installed around the stadium at different angles. However, installing OTS equipment in all stadiums is not easy, and it is particularly challenging to equip training fields or away-game stadiums with OTS facilities. Furthermore, when it is attempted to implement OTS with a limited number of cameras, low-quality raw data may be obtained, which may result in requiring a manual correction process and thus prevent the acquisition of reliable tracking data.

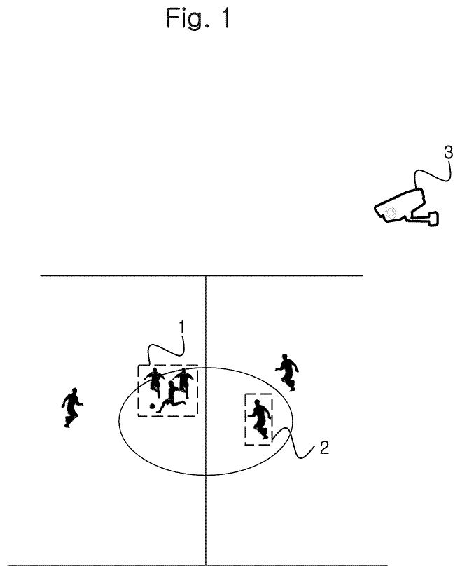

In this regard, FIG. 1 illustrates acquisition of image-based locational information. As shown in FIG. 1, a positioning method may be used to calculate the position of a player from images captured by a camera 3.

According to the image-based positioning method, a player's position may be accurately calculated only if the player to be tracked in the video is recognized.

For example, for a player located in the second area 2 of FIG. 1, the player may be recognized, allowing the calculation of the position of the player to be tracked.

However, for a player located in the first area 1 of FIG. 1, an occlusion event may occur, which makes it difficult to recognize the player. Specifically, since the first area 1 is populated with multiple players, occlusion may occur where the player to be tracked is occluded by other players in the video. Consequently, the position of the target player to be tracked, who is occluded by other players, may not be accurately acquired.

In other words, the image-based positioning method may not be able to handle occlusion situations where the player to be tracked is occluded by other players in the video.

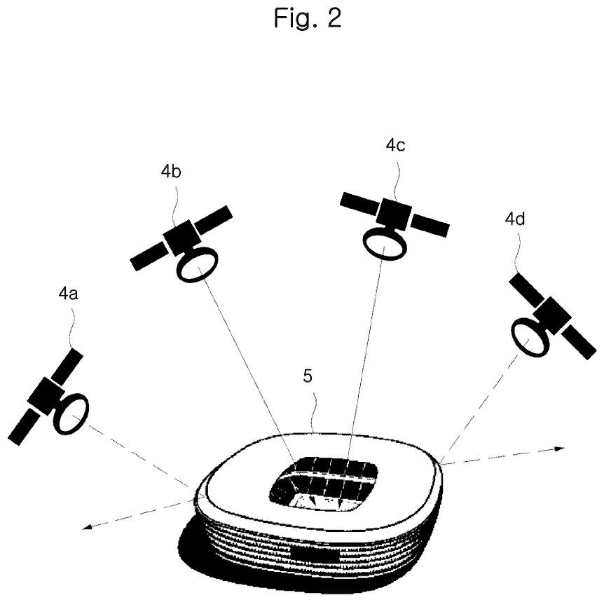

FIG. 2 illustrates acquisition of sensor-based locational information. As shown in FIG. 2, for example, a positioning method that calculates the position of a player using a sensor-based positioning device, such as a GPS module, may be employed.

Specifically, the positioning method using a GPS module may calculate the position of a player to be tracked based on signals transmitted from satellites (4a, 4b, 4c, 4d). However, signals transmitted from satellites may be significantly affected by surrounding structures near the player to be tracked.

For example, GPS signals transmitted from a portion of satellites (4b, 4c) of FIG. 2 may reach the pitch without being affected by surrounding structures near the player to be tracked. However, GPS signals transmitted from other satellites (4a, 4d) may be influenced by surrounding structures, preventing them from reaching the interior of the pitch. At this time, if GPS signals transmitted from particular satellites (4a, 4d) are obstructed by surrounding structures, errors may occur in the player's position calculated from the GPS signals.

Meanwhile, for object tracking, it is necessary to detect and identify the object. In other words, tracking a specific object may involve obtaining information on the continuous positions of the object over a predetermined time interval to determine its trajectory. For example, in team sports, object tracking is often performed for a plurality of objects rather than a single object; therefore, after detecting a plurality of objects, identifying which detected object corresponds to which actual object is essential for object tracking.

In this regard, for sensor-based positioning methods such as GPS or LPS, a separate identification process may not be required. A plurality of sensors used for acquiring locational information may correspond to specific objects among a plurality of objects, and each sensor device may be configured to have a unique device ID. Consequently, the locational information measured by a particular sensor may be directly associated with a specific object using the device ID without involving a separate identification process.

On the other hand, in image-based positioning methods such as OTS, when a plurality of objects are detected in each frame of a video consisting of multiple frames, it is necessary to identify which object in one frame corresponds to which object detected in the next frame. In other words, for example, if first to tenth objects are present as tracking targets, and ten objects are detected in both the first and second frames, it has to be determined which object in the first frame corresponds to which object in the second frame to obtain tracking data for the trajectories of the objects by performing matching of time-series information over a predetermined time interval.

To this purpose, the process for acquiring tracking data using image-based locational information may include an object detection process for each frame and an object matching process between frames. However, errors may occur in both the object detection process and the object matching process.

First, in the object detection process, a false negative error may occur when an object is incorrectly determined to be absent while it is actually present, or a false positive error may occur when an object is incorrectly determined to be present while it is actually absent.

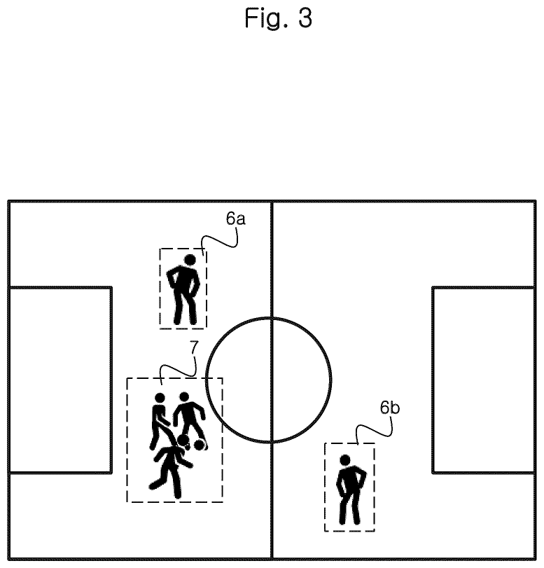

FIG. 3 illustrates a false negative error state in which an undetected object exists. As shown in FIG. 3, objects located in the detection areas (6a, 6b), such as the bounding box in an image acquired by a camera, may be detected normally; however, the three objects located in the detection area 7 may be affected by mutual occlusion, and at least one of the three objects may remain undetected. In other words, some objects among the objects to be tracked may not be detected in the corresponding frame.

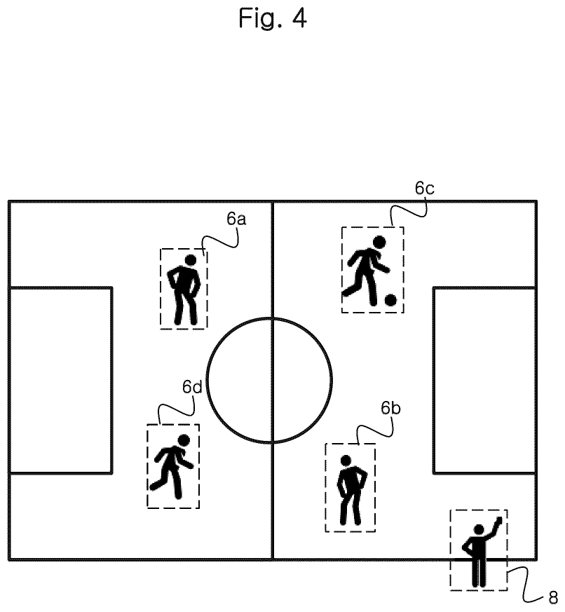

FIG. 4 illustrates a false positive error state in which a falsely detected object exists. As shown in FIG. 4, objects located in the detection areas (6a, 6b, 6c, 6d) may be detected normally. However, an object located in the detection area 8 may be, for example, a referee, which is not a target object for tracking and therefore should not be detected; however, erroneous detection of the object may occur, causing a problem. For example, in some frame, 11 objects may be detected instead of 10 objects expected to be detected; in another frame, a detection failure of a specific object may occur simultaneously with false detections, leading to detecting 9 target objects for tracking along with detection of 1 non-target object, totaling 10 detected objects.

Errors in the object detection process may further increase the likelihood of error occurrence in the object matching process. To acquire continuous locational information of a specific object, matching between detected objects in consecutive frames may be performed. Various algorithms may be selected for matching detected objects between frames; for example, the Hungarian algorithm, which minimizes the matching cost such as the sum of distance differences between objects, may be applied.

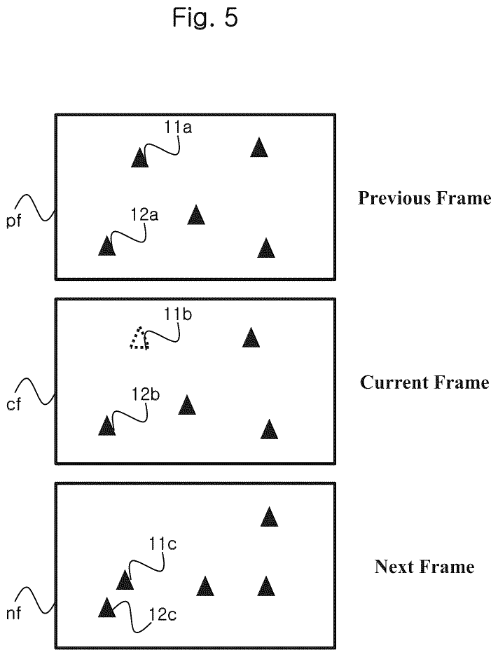

FIG. 5 illustrates object matching between frames in a video containing a plurality of objects. Depending on the arrangement of the detected objects, for example, such as when a distance between specific objects is very close, a matching error may occur in which different objects in each frame are matched; particularly, if an error has already occurred in the object detection stage, the likelihood of error occurrence further increases. As shown in FIG. 5, the object matching process performed across multiple frames is described, including the previous frame pf, the current frame cf, and the next frame nf. The three objects on the right side of the frames without specific labels may be matched between frames without causing a particular issue. However, errors in matching between frames for the first object 11 and the second object 12 are analyzed with reference to FIG. 5. The first object 11 may be detected as an object 11a in the previous frame and as an object 11c in the next frame; however, in the current frame, it should have been detected as an object 11b, but due to an error in the object detection process, it may not be detected. The second object 12 may be detected as an object 12a in the previous frame, as an object 12b in the current frame, and as an object 12c in the next frame. When examining object matching between frames, object 12a and object 12b may be matched when object matching is performed in the previous and current frames, while object 11a may be determined to have no matching object. When object matching is performed between the current and next frames, an ambiguity problem may occur as to whether object 12b should be matched with object 11c or object 12c. If object 12b is matched with object 11c, an error occurs in which the first and second objects are falsely matched. Even when multiple objects are in relatively close proximity, if the objects make continuous movements, proper object matching between frames may be performed; however, as shown in FIG. 5, if the detected position of the first object 11 suddenly shifts from the position of object 11a to the position of object 11c, proper object matching between frames may not be achieved.

In other words, when objects are tracked using image-based locational information such as OTS, issues may arise not only in object detection but also in the frame-by-frame matching of detected objects. To address the issues, a method has been proposed in which a plurality of cameras are installed at various distinct points surrounding the objects and images captured from a plurality of angles are utilized; however, the proposed method not only incurs high installation costs but also presents challenges in securing appropriate locations within the pitch to accommodate such a large number of cameras.

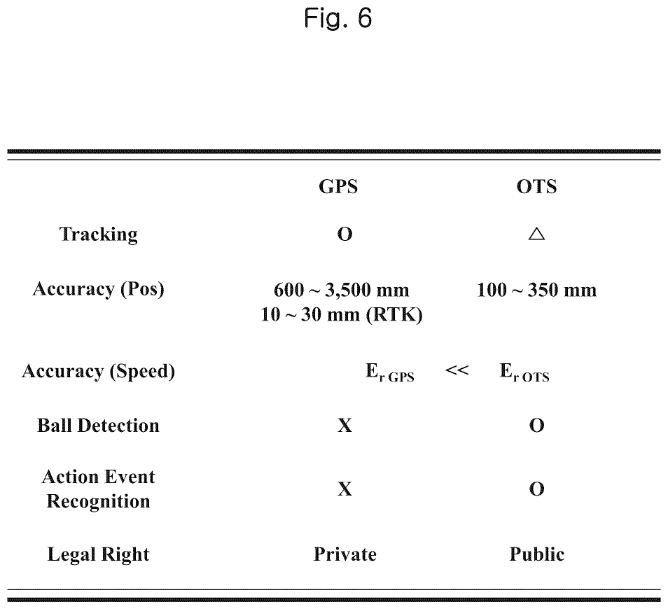

As described above, object tracking using image-based locational information such as the OTS and sensor-based locational information such as the GPS may each have distinct advantages and disadvantages. FIG. 6 illustrates a comparison between the GPS method and the OTS method.

As shown in FIG. 6, in terms of object tracking, GPS enables tracking of a specific object simply by collecting time-series position data from a specific sensor without involving a separate identification process using the sensor device ID corresponding to each object. On the other hand, OTS requires consideration of potential errors in the object detection and frame-to-frame matching processes.

However, in terms of position accuracy, GPS generally has an error range of approximately 600 to 3,500 mm. In contrast, OTS may obtain object locational information with high accuracy, within an error range of 100 to 350 mm.

Regarding the accuracy of displacement-based information such as speed, the GPS method may achieve higher accuracy than the OTS method. Due to factors such as Doppler shift measurements using satellite signals, unlike the accuracy observed when the position is determined at a specific time point, the measurement error E_{rGps} in the displacement-based information, such as the speed measured by the GPS method, is significantly lower than the measurement error E_{rOTS} from the OTS method.

The OTS method is advantageous in the position detection of a ball used in a sports game. The OTS method is able to detect the ball position by processing of a captured video without inserting a specific sensor or device into the ball. On the other hand, detecting the ball's position using GPS requires embedding a GPS sensor within the ball; however, especially in professional sports where game outcomes are treated in a highly sensitive way, insertion of sensors into the ball, which may influence the gameplay, often faces strong opposition.

In terms of action event recognition in sports matches, the OTS method is more advantageous. Since the GPS method primarily acquires object locational information, recognizing specific actions such as a pass or a kick is a formidable task. On the other hand, because the OTS method involves video analysis, it is possible to detect specific action events, such as a player's kick or pass, by establishing appropriate image processing procedures and image analysis algorithms.

From the perspective of legal rights, the OTS method may be somewhat more advantageous. In the case of the GPS method, the data measured through GPS may belong to the owner of the GPS sensor. For example, in the case of sports data, the rights to GPS-based data collected from players of a sports club belong to the club. In sports analytics, analyzing the performance of a competing team is just as crucial as analyzing the club team's own performance; however, acquiring GPS data on the players of the competing team may not be easy. On the other hand, sports videos used for the OTS method, such as those broadcast through sports channels, may be publicly available through broadcasting of the sport game. Therefore, by analyzing broadcast videos, it is possible to acquire tracking data on players or games of other teams and utilize the acquired tracking data accordingly.

As described above, object tracking methods using image-based and sensor-based locational information have distinct advantages and disadvantages. However, from an economic viewpoint, the OTS method requires not only a plurality of high-performance cameras to address the occlusion problem but also a high-capacity data storage system to store and process video data for analysis. When commercial cloud systems are employed to implement the storage system, the large volume of video data may lead to significant cloud service costs; even when dedicated servers are installed at a stadium, substantial expenses are required to set up the server system; moreover, even if a server is installed, the server is typically restricted to the home stadium, making it difficult to analyze sports videos from away games or training sessions.

In this regard, the disadvantages of GPS except for the measurement accuracy may be considered acceptable when its advantages are considered; even in terms of measurement accuracy, introduction of the RTK solution may reduce the error range to approximately 10 to 30 mm. Although adopting a high-precision RTK solution may entail significant costs, RTK offers a practical approach to improve accuracy while maintaining installation costs at a reasonable level through customizable configurations.

The embodiments of the present disclosure take the above considerations into account; according to the embodiments of the present disclosure, player information may be efficiently displayed on the captured video without incurring high costs for image analysis by acquiring locational information of each player participating in a sports event based on sensors and displaying at least part of the acquired locational information and supplementary information derived from analysis at the corresponding positions in the captured video related to the sports event.

In other words, by introducing a sensor-based position acquisition method with improved accuracy, such as RTK-GPS, it is possible to enhance the accuracy of sensor-based position data to a reasonable level; by displaying the acquired sensor-based position data at appropriate positions in the sports video, tracking data such as a player's position, speed, and trajectory may be integrated into the sports video without incurring costs associated with image-based position tracking.

In what follows, for the convenience of description, the present disclosure may described the RTK-GPS as an example of an improved sensor-based position acquisition method; however, it should be noted that the description is given merely for the illustrative purpose, and the sensor-based locational information according to the embodiments of the present disclosure is not limited to the RTK-GPS.

### Terms

Specific technical terms may be used for the present disclosure; in what follows, terms used herein are described to establish definitional support for the terms.

The following is a summary of the preferred definitions of several terms used in the present disclosure. The definitions provided below are merely exemplary and are neither exhaustive nor restrictive.

The term “image-based locational information” may refer to information on the position of an object determined using an image containing the object. The image-based locational information may include information on the position of at least one object determined from a captured image of one or more objects. For example, the image-based locational information may include, but is not limited to, information on the position of each player determined by analyzing a video of a team sport game in which a plurality of players participated and should be interpreted in a comprehensive sense to include locational information acquired from captured images of any type of object.

The term “sensor-based locational information” may refer to information on the position of an object determined using a signal from a sensor corresponding to the object. The sensor-based locational information may include information on the position or displacement of at least one object determined based on signals from sensors corresponding to each of one or more objects. For example, the sensor-based locational information may include, but is not limited to, locational information acquired through positioning solutions utilizing the Global Navigation Satellite System (GNSS) such as GPS or utilizing a Local Positioning System (LPS) and should be interpreted in a comprehensive sense to include locational information of an object acquired through signals from a sensor corresponding to the specific object.

For example, an acceleration-related signal may be measured from an inertial measurement unit (IMU) corresponding to an object, and by integrating the acceleration measurement value, velocity information may be obtained; furthermore, by integrating the velocity information again, displacement may be acquired, thereby implementing a method of measuring the movement path of the corresponding object. The displacement information of an object should also be interpreted as being included in the sensor-based locational information.

### System

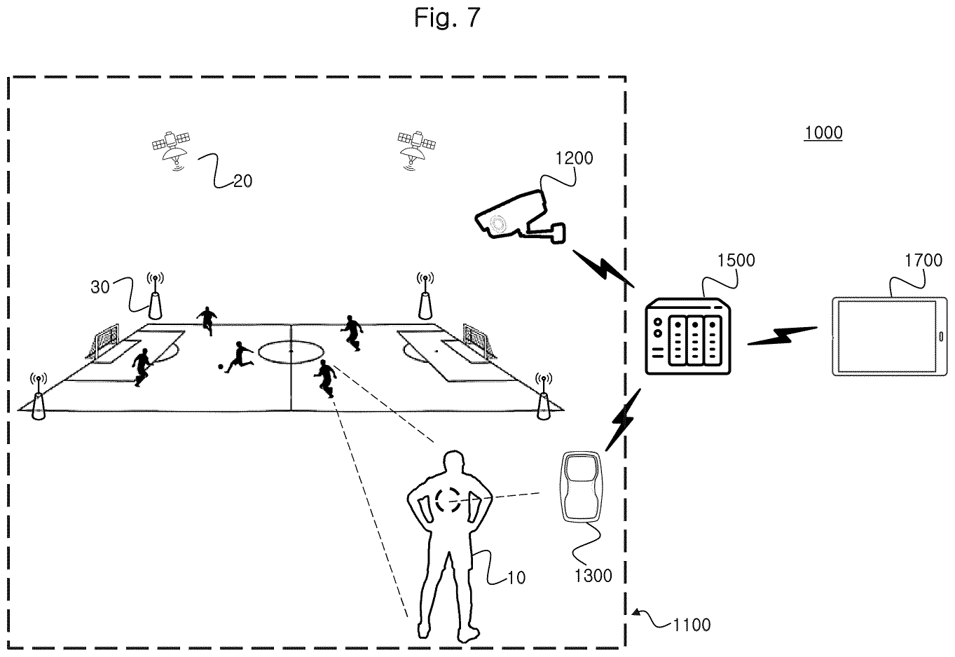

FIG. 7 illustrates an exemplary system in which a method for displaying player information according to one embodiment of the present disclosure may be performed. In what follows, a system 1000 for displaying player information according to an embodiment of the present disclosure will be described with reference to FIG. 7. However, the procedure for displaying player information according to the present disclosure should not be interpreted as being performed only by the system configuration shown in FIG. 7; it should be understood that any hardware configurations for acquiring sensor-based locational information and displaying the locational information at the corresponding position in a sports video and a combination of the configurations may be adopted for implementing the method for displaying player information according to embodiments of the present disclosure.

As shown in FIG. 7, the system 1000 may comprise a sensing platform 1100 and a server 1500. According to one aspect, the system 1000 may further include a terminal 1700.

The system 1000 may detect information on an object, for example, a player 10, over a target time interval through the sensing platform 1100 and determine information on the player from the detected information through the server 1500. Also, the system may display trajectory information of the determined object through the terminal 1700. FIG. 7 illustrates the server 1500 and the terminal 1700 as separate entities; however, it should be noted that the embodiments of the present disclosure are not limited thereto. For example, a tablet PC integrating the server 1500 and the terminal 1700 may be used to provide player information in real-time and simultaneously display player information along with a sports video. Furthermore, although not shown in FIG. 7, the system may also be configured such that a relay device, such as a live hub, is further provided before the server 1500 to receive data for collecting information from the sensing platform 1100, information from a plurality of devices included in the sensing platform are received by the relay device, and the received information is again transmitted to the server 1500 or the terminal 1700.

In what follows, exemplary components of the object tracking system according to an embodiment of the present disclosure will be described.

### Sensing Platform

The sensing platform 1100 may detect various types of information on an object 10, for example, a player. For example, the sensing platform 1100 may perform positioning of the object 10 or detect the movement of the object 10.

For example, the sensing platform 1100 may detect kinematic information related to the object 10. Kinematic information refers to information regarding the position, orientation, and movement of the object 10, which may include at least one of locational information, orientational information, and movement information; movement information may include at least one of velocity, acceleration, jerk, angular velocity, angular acceleration, angular jerk, their magnitudes (e.g., speed in the case of velocity) and their directions (e.g., movement direction in the case of velocity).

The results of the positioning performed by the sensing platform 1100 on the object 10 may be provided as locational information; alternatively, the object's position may be determined by processing at least one or a combination of the kinematic information and then provided as locational information.

The sensing platform 1100 may be implemented in various forms to detect the various types of information. For example, the sensing platform 1100 may be implemented as a sensor-based platform utilizing sensor devices 1300, which are provided to correspond to each object 10 and transmit signals based on measurement results.

### Sensor-Based Platform

In what follows, a sensor-based sensing platform will be described.

The sensor-based sensing platform may include a sensor device 1300. The sensing platform may acquire activity information regarding an object 10 corresponding to the sensor device 1300 using the sensor embedded in the sensor device 1300. In one aspect, the sensor device 1300 may be implemented as an attachable device affixed to each object 10; however, the sensor device is not limited to the specific implementation and may include any type of device configured to perform sensing of the corresponding object.

The sensor device 1300 according to one embodiment may be attached to the object 10 and utilized to detect activity information of the object 10. For example, the sensor device 1300 may include a Global Positioning System (GPS) sensor and be used for positioning the object 10 to which the sensor device 1300 is attached.

One or more sensor devices 1300 may be attached to one object 10. In particular, when it is difficult for a single sensor device 1300 to obtain all the information required by the sensing platform, a plurality of sensor devices 1300 may need to be attached to one object 10. For example, an attachable device including a GPS sensor and an Inertial Measurement Unit (IMU) sensor and another attachable device including a heart rate sensor may be attached to the torso and wrist of the object 10, respectively, while the device attached to the torso may be configured to sense the position and movements of the object 10.

For example, the sensor-based sensing platform may acquire kinematic information using the sensor device 1300.

In what follows, several examples of acquiring kinematic information by the sensor-based sensing platform will be described.

The sensing platform may acquire locational information using a positioning module of the sensor device 1300.

For example, the sensor device 1300 may include a global positioning module (also referred to as a satellite positioning module or a Global Navigation Satellite System (GNSS) module), and the sensing platform may measure the location of the object 10 by performing global positioning using the module. Specifically, the sensing platform may perform global positioning for the object 10 by receiving satellite signals from navigation satellites 20 through the GNSS module and calculating a global position (e.g., latitude and longitude) using a triangulation method from the received satellite signals. Meanwhile, the sensing platform may include a base station to perform Real-Time Kinematic (RTK) positioning for more accurate positioning. The sensing platform may utilize the global position directly as activity information or process the global position into a local position defined in the pitch coordinate system for the sports field and use the local position as activity information. Here, the pitch coordinate system may be a two-dimensional plane coordinate system with the length and width directions of the field as axes and a specific point on or around the sports field (e.g., one of the corners or the center of the sports field) as the origin. Meanwhile, it should be noted that all location-related information processed below may be handled in an unlimited manner according to the pitch coordinate system.

In another example, the sensor device 1300 may include a local positioning module, and the sensing platform may measure the location of the object 10 by performing local positioning using a local positioning sensor network that includes the sensor device 1300. The local positioning sensor network consists of a moving tag node attached to a positioning target object and anchor nodes 30 that are fixedly installed within the positioning area; positioning may be performed using Local Positioning System (LPS) signals transmitted and received between the tag node and the anchor nodes. The sensing platform may perform local positioning using transmission and reception results of LPS signals between the sensor device 1300, which includes a local positioning module and operates as a tag node by being attached to the positioning target object 10, and anchor nodes 30, which are fixedly installed on or around the sports field.

The sensing platform may obtain movement information and/or directional information using the motion sensing module of the sensor device 1300.

For example, the sensor device 1300 may include an IMU sensor (or an Attitude and Heading Reference System (AHRS) sensor), and the sensing platform may acquire movement information and/or directional information of the object 10 or a body part of the object 10 by utilizing acceleration, angular velocity, and heading angle detected by the IMU sensor. If the sensor device 1300 is attached to the torso of the object 10, movement information related to the positional displacement of the object 10 may be obtained; if the sensor device 1300 is attached to the arm or leg of the object 10, movement information of the arm or leg of the object 10 may be acquired.

Meanwhile, the sensing platform may calculate other types of kinematic information using the measured kinematic information. For example, the sensing platform may calculate velocity based on the global position measured continuously from the GPS module and the GPS module's sampling interval. Since the calculation of kinematic information may be performed through simple mathematical operations, such as vector operations or differentiation and integration with respect to the time, a detailed description thereof is omitted. Here, the calculation of kinematic information may be performed internally within the sensor device 1300 or in the server 1500, which receives information from the sensor device 1300; within the sensor device 1300, the sensing module may directly perform the calculation, or a controller of the sensor device 1300 may perform the calculation based on the detection results from the sensing module.

### Sensor Device

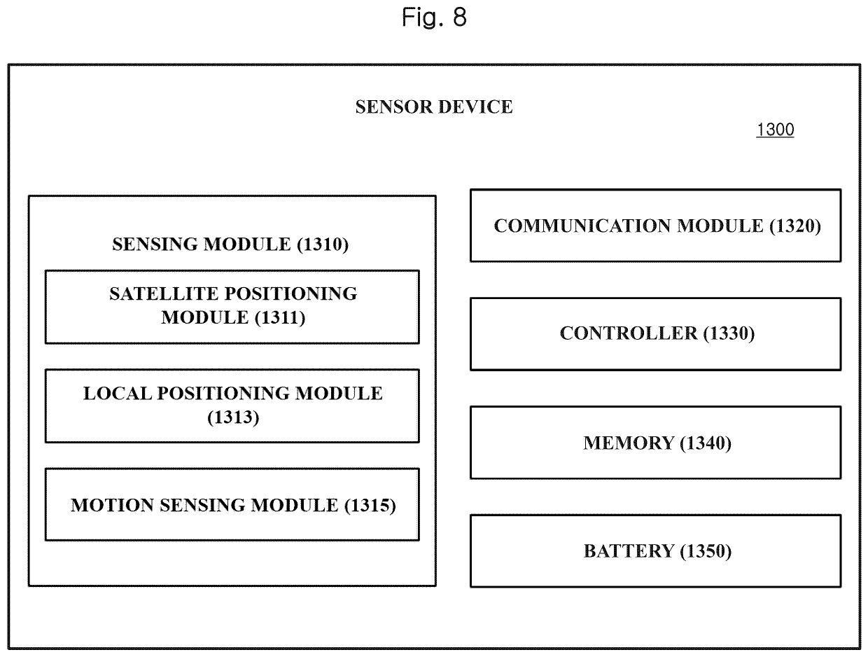

FIG. 8 is a block diagram of a sensor device that may be used for obtaining sensor-based locational information according to one embodiment of the present disclosure.

As illustrated in FIG. 8, the sensor device 1300 according to one embodiment of the present disclosure may include a sensing module 1310, a communication module 1320, a controller 1330, a memory 1340, and a battery 1350.

The sensing module 1310 may detect various signals to acquire activity information. The sensing module may be a positioning module or a motion sensing module.

The positioning module may be a satellite positioning module 1311 or a local positioning module 1313. The satellite positioning module 1311 may perform positioning using a navigational satellite system, namely GNSS. Here, GNSS may include a Global Positioning System (GPS), GLONASS, BeiDou, and Galileo. Specifically, the global positioning module may include a satellite antenna that receives satellite signals and a positioning processor that performs positioning using the received satellite signals. For example, the satellite positioning module may be a GPS module including a GPS antenna that receives GPS signals and a GPS processor that performs positioning using the GPS signals. At this time, the sensor device 1300 may function as a GPS receiver, receiving GPS signals from satellites to obtain latitude, longitude, altitude, speed, heading, Dilution of Precision (DOP), and time.

The local positioning module 1313 may perform positioning in cooperation with a sensor network. The sensor device 1300, including a local positioning module, may function as a tag node in a local positioning sensor network and transmit and receive LPS signals to and from surrounding anchor nodes, where positioning may be performed based on the transmission and reception results of the LPS signals. For example, the sensor device 1300 may transmit LPS signals as a transmitter in a sensor network for local positioning, and anchor nodes may receive the LPS signals; alternatively, anchor nodes may transmit LPS signals, and the sensor device 1300, operating as a receiver in the sensor network for local positioning, may receive LPS signals. At this time, the LPS signals may be periodically broadcast according to communication methods such as Ultra-Wide Band (UWB), Bluetooth, Wi-Fi, or RFID, and the LPS signals may include timestamps or device identifiers. Position estimation may be performed based on the measurement results from the transmission and reception of LPS signals, and methods such as Received Signal Strength (RSS), Time-of-Arrival (ToA), Time Difference-of-Arrival (TDoA), Angle-of-Arrival (AOA), triangulation, and hyperbolic triangulation may be used for position estimation. Position estimation may be performed by a master of the sensor network, and any of the tag node, anchor nodes, or server may function as the master of the sensor network. If the sensing platform further includes an RTK base station, the master's position estimation function may be embedded in the base station.

The motion sensing module 1315 may also be referred to as a kinematic sensing module and may detect movement and/or pose. Here, the motion sensing module 1315 may include an IMU module or an AHRS module; the IMU module and the AHRS module may include an accelerometer and a gyroscope, and optionally a magnetometer and may measure movement and pose from on the sensor detection results.

Meanwhile, the sensing module does not necessarily have to be equipped in every sensor device 1300, and a plurality of identical sensing modules may be included in a single sensor device 1300; moreover, different sensor devices 1300 may have different sensing modules. For example, the sensing platform may include two different sensor devices 1300: one attached to the torso of object 10 and another attached to the wrist of object 10. The devices include a GPS sensor and an Inertial Measurement Unit (IMU) sensor to acquire locational and movement information on the object 10.

The sensor device 1300 may transmit and receive data with an external device such as the server 1500 or another sensor device 1300 via the communication module 1320. The communication module 1320 may perform wired and/or wireless communication. The sensor device 1300 may use a wireless communication module that performs communication via a mobile communication network (e.g., LTE, 5G), Wi-Fi, Bluetooth, Zigbee, or other various wireless communication specifications to exchange data with external devices. For example, the wireless communication module 1320 may enable the sensor device 1300 to transmit data acquired via the sensing module 1310 to server 1500 in real-time for monitoring of the object 10 using activity information by the system; also, if a plurality of sensor devices 1300 are attached to a single object 10, data may be exchanged among the sensor devices. Also, the sensor device 1300 may also use a wired communication module that supports Universal Serial Bus (USB) communication or wired Local Area Network (LAN) communication to exchange data with external devices. For example, the wired communication module may transfer data collected by the sensor device 1300 in bulk to the server 1500 or to a docking station that handles charging and/or data management of the sensor device 1300.

The controller 1330 may control the overall operation of the sensor device 1300. The controller 1330 may be implemented in hardware, software, or a combination thereof. From a hardware perspective, the controller 1330 may be provided in various forms capable of performing computations or data processing, such as an electronic circuit, an integrated circuit (IC), a microchip, or a processor. Also, since the physical configuration of the controller 1330 is not necessarily limited to a single physical entity, the controller 1330 may be provided as a single processor that handles all processing within the sensor device 1300, as a plurality of processors that each perform different functions, or in a form integrated with other constituting elements of the sensor device 1300. For example, the controller 1330 may be provided in a form including a main processor that manages and controls the overall operations of a GPS processor that processes GPS signals for positioning, an IMU processor that performs various calculations using the sensing results from the IMU module, and the sensor device 1300.

The memory 1340 may store various data related to the operation of the sensor device 1300. For example, the memory 1340 may store firmware that governs the operation of the sensor device 1300 or detection results from the sensors of the sensor device 1300. The memory 1340 may be provided in various forms of volatile or non-volatile memory.

The battery 1350 may supply the power necessary to operate the sensor device 1300. The battery 1350 may be provided as either a built-in or a detachable type and may be charged by receiving power from an external power source.

### Sports Video Acquisition Platform

In what follows, a sports video acquisition platform will be described. The sports video acquisition platform may include, for example, a camera 1200.

The camera 1200 may be disposed in or around the sports field to capture images of the field or objects 10 moving in the field for applications in sports analysis. The camera 1200 may be installed in a semi-permanent manner (e.g., attached to an accessory facility of the field), temporarily (e.g., mounted on a mobile pole), or handheld by an operator of the camera. The sports video captured by the camera 1200 may include a tactical view, a broadcasting view, or a player-focused view. The tactical view is generally used for sports tactical analysis, capturing most objects 10 in the frame to analyze team tactics, and the horizontal axis of the tactical view may correspond to the length or width of the field. The broadcasting view is mainly used for sports broadcasting, typically featuring a narrower field of view than the tactical view, and the player-focused view follows a specific object 10 and is primarily used for analyzing individual performance of the object 10. The camera 1200 is not necessarily limited to a fixed viewing angle; adjustments of the viewing direction and zoom settings may be performed manually or automatically.

According to one aspect of the present disclosure, the sports video acquisition platform may include one or more cameras. A plurality of cameras may be provided in a multi-camera arrangement at a single spot to capture a panoramic video or may be distributed across multi-spots, or a combination of both configurations may be used.

The sports video acquisition platform may be configured to acquire various types of sports videos through the camera 1200.

Meanwhile, according to one aspect, image-based locational information may be acquired separately from sensor-based locational information. For example, the sensing platform may analyze the video captured by the camera 1200 to extract activity information. For example, the sensing platform may perform object recognition on the image to detect a object 10, extract the position of the object 10 in the image (e.g., pixel coordinates), and project the position in the image onto the ground using the pose information of the camera 1200 to obtain the locational information of the object 10. Deep learning algorithms may be employed for video processing, such as object detection. More specifically, various deep learning algorithms for object detection, ranging from Region-based Convolutional Neural Network (RCNN) to You-Only-Look-Once (YOLO), may be utilized for object detection (e.g., detection of the object 10), while top-view transformation using camera parameters (e.g., installation position, capture pose) may be used for coordinate conversion. For example, the server 1500 may acquire a sports video from the camera 1200 disposed to capture a tactical view, obtain bounding boxes for sports objects such as a ball or the object 10 from the sports video through an artificial neural network model that performs object detection, determine a representative pixel (e.g., the lower center of the bounding box) for each detected object, and acquire locational data for the sports objects by performing top-view transformation using a coordinate conversion metric between the reference coordinate system and the pixel coordinate system defined in the sports video generated based on the camera parameters with respect to the representative pixel determined. Here, object detection using an artificial neural network may be replaced by object segmentation. Accordingly, the server 1500 may obtain locational data for sports objects within the sports video captured by the camera 1200 through video analysis.

As described above, the sensing platform 1100 may further include a base station for RTK correction and anchor nodes for constructing a local positioning sensor network selectively as needed.

Also, part of the various computations performed in the sensing platform 1100 may be processed by the processor or controller embedded in the sensor device 1300, while other parts may be handled by the server 1500. For example, object detection in the video may be processed by the server 1500; position estimation based on the transmission and reception results of LPS signals between nodes in the local positioning sensor network may be handled by the server 1500; and various processing tasks related to video analysis may also be performed by the server 1500. Therefore, in this case, the server 1500 may be understood as being included in the sensing platform 1100.

### Server

The server 1500 may be configured to receive locational information from the sensing platform 1100 or operate in conjunction with the sensing platform 1100 to acquire locational information and use the acquired locational information to track the trajectory of an object.

The server 1500 may be provided as a local server located near the sports field and/or a web server connected via the internet. Also, the server 1500 does not necessarily have to be implemented as a single entity; for example, the web server may be configured to include a main server that handles computations and a data server that stores various types of data. Meanwhile, the local server may be provided as a device operating independently to perform only the functions inherent to the server; however, the local server may also be provided as a multifunctional device integrated with other constituting elements of a sports workload information provision system. For example, the server may be provided in the form of a docking station that serves as a container for accommodating, storing, and managing sensor devices 1300. Here, the docking station may include a docking space to accommodate the sensor device 1300 and an internal space for storing multiple sensor devices 1300 when they are not in use. Furthermore, the docking station may offer various convenience functions necessary for using the sensor devices 1300 in addition to merely storing them. For example, the docking station may perform the functions such as charging, battery status indication, firmware updates, and data collection for the sensor devices 1300.

Also, as described above, the server may be integrated with the terminal 1700 and, for example, may be a mobile computing device such as a tablet PC.

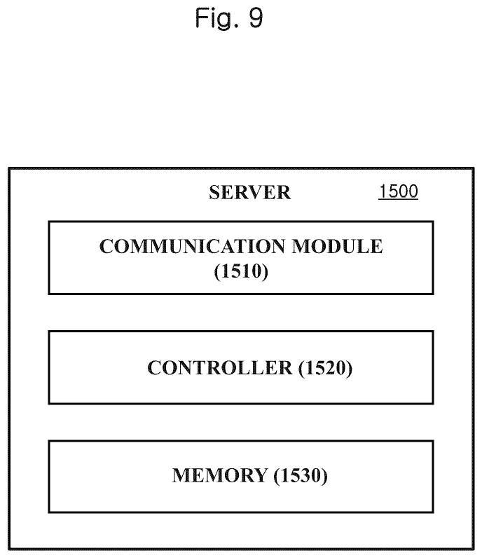

FIG. 9 is a block diagram of a server according to one embodiment of the present disclosure.

The server 1500 may include a communication module 1510, a controller 1520, and a memory 1530.

The communication module 1510 may perform data transmission and reception between the server 1500 and other constituting elements of the object tracking system or external devices. For example, the server 1500 may collect data from the sensor device 1300 via the communication module 1510, receive a video from the camera 1200, or transmit various types of information to the terminal 1700 through the web.

The controller 1520 may control the overall operation of the server 1500. In the same way as the controller of the sensor device 1300, the controller 1520 of the server may be implemented in hardware, software, or a combination thereof; from a hardware perspective, the controller may be provided in various forms capable of performing computations or data processing, such as an electronic circuit, an integrated circuit (IC), a microchip, or a processor; also, the physical configuration of the controller is not necessarily limited to a single physical entity. Meanwhile, the specific operations performed by the server 1500 will be described later, and unless otherwise specified, it should be understood that the methods or operations according to the embodiments of the present disclosure described later are performed by the controller 1520 of the server.

However, as described in the present disclosure, the embodiments of the present disclosure are not necessarily performed solely by the controller 1520 of the server; it should be understood that the embodiments of the present disclosure may, for example, be performed by any computing processor, such as the controller 1330 of the sensor device 1300, or at least part of the process may be performed by the server, while at least different part of the process may be performed by a different processor.

### Terminal

The terminal (or terminal device) 1700 may function as a user interface that provides various data or information collected or generated by the system to the user or receives user input from the user. For example, the terminal 1700 may receive input from the user regarding the pitch corners or the location of a specific player within the sports video and transmit the received information to the server 1500 to determine the corresponding positions of each of a plurality of players within the sports video. Also, based on the determined corresponding positions, the terminal 1700 may display the sports video along with information on the plurality of players, thereby providing integrated contents to the user. The terminal 1700 may be a smart device like a smartphone or a tablet, a personal computer like a laptop or a desktop, or any electronic device equipped with an input interface receiving user input and an output interface such as a display.

### Player Information Display on a Sports Video

In what follows, a procedure for displaying player information on a sports video according to an embodiment of the present disclosure will be described. In what follows, it is assumed that the system 1000 described above performs the procedure for displaying player information; however, the description is provided only for the convenience of description, and therefore, the present disclosure is not limited to the specific situation in which the procedure is performed by the system.

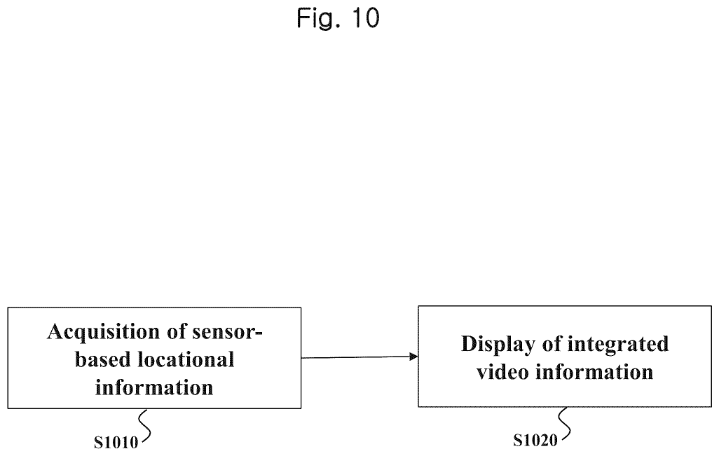

FIG. 10 is a conceptual diagram of a method for displaying player information on a sports video according to one embodiment of the present disclosure. The method for displaying player information on a sports video according to the embodiments of the present disclosure may include a procedure for acquiring sensor-based locational information S1010 and an integrated display procedure for video information S1020.

More specifically but not exclusively, as shown in FIG. 10, the method for displaying player information on a sports video according to embodiments of the present disclosure may include a procedure for acquiring locational information for each of a plurality of players based on sensor devices such as GPS S1020. Based on the acquired locational information, not only the player's position but also various supplementary information determined from the locational information, such as speed or trajectory, may be determined. Subsequently, in the step of displaying integrated video information S1020, the determined supplementary information may be integrated into the corresponding positions within the sports video for each player, allowing the user to receive a sports video integrated with player information.

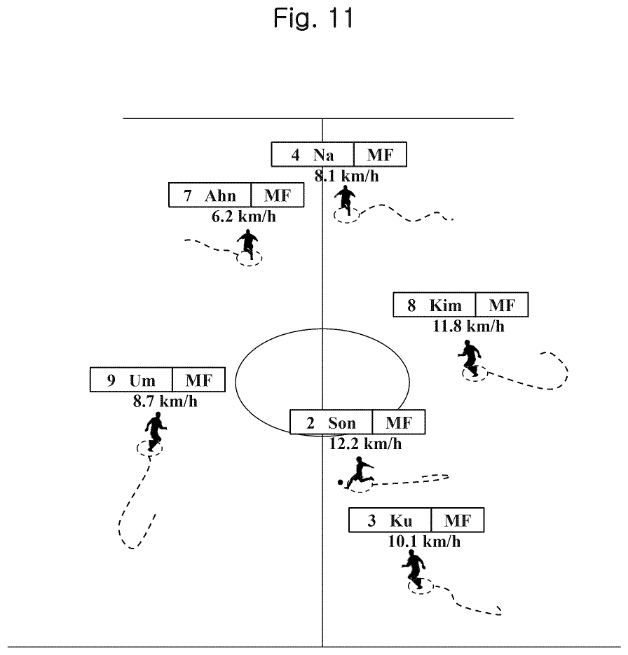

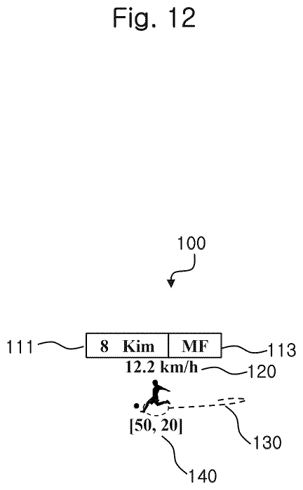

FIG. 11 is an exemplary diagram of a state in which player information is displayed on a sports video according to one embodiment of the present disclosure, and FIG. 12 provides a detailed description of the player information displayed in FIG. 11. As shown in FIG. 11, the sports video may include a plurality of players, and information regarding each player may be displayed at an appropriate position corresponding to each player. According to embodiments of the present disclosure, the player information displayed in the sports video may be determined based on sensor-based locational information acquired using sensors.

As illustrated in FIG. 12, according to one aspect of the present disclosure, the player information 100 that may be displayed in the sports video may include at least one of the corresponding player's personal information 111, 113, sensor-based locational information 140, speed 120, and trajectory 130 over a predetermined time interval.

As shown in FIG. 12, for example, personal information of a player may include, but is not limited to, the supplementary information such as the player's jersey number, name 111, or position 113.

The player's speed 120 may be the speed determined over a predetermined time interval at the time the player information is displayed in the sports video or at a time preceding by a predetermined time interval. The speed may be calculated based on the player's locational information determined by the sensor device, or it may be speed information directly acquired and transmitted by the sensor device.

The player's trajectory 130 may be time-series information on locations where the player was present over a predetermined time interval. As illustrated in FIG. 12, the player's trajectory may be displayed on the sports video in a parabolic or curved form. The time length of the locational information displayed as a trajectory may be changed based on, for example, the input value configured by the user.

In one aspect, sensor-based locational information 140 of the player may be displayed together in the sports video. As illustrated in FIG. 12, sensor-based locational information 140 may be displayed as coordinate values, for example. These coordinate values may correspond to coordinates in the pitch coordinate system, coordinates in the global coordinate system or video coordinate system, which are not limited to any specific coordinate system. Also, in another aspect, instead of displaying specific coordinate values, the player's locational information may be displayed in the form of a particular shape, such as a circle, which indicates the corresponding position below the player in the video.

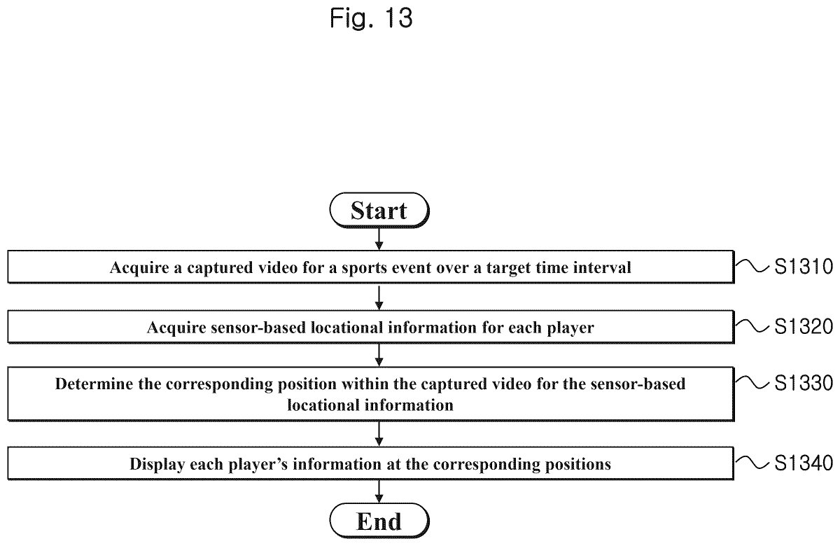

FIG. 13 is a schematic flowchart of a method for displaying player information on a sports video according to one embodiment of the present disclosure. Hereinafter, with reference to FIG. 13, a method for displaying player information in a sports video according to one embodiment of the present disclosure will be described in more detail.

For example, the method according to an embodiment of the present disclosure may be performed by a computing device. For the convenience of description, the methods according to embodiments of the present disclosure may be described as being performed by a computing device. Here, the computing device may be, for example, the server 1500 or the terminal 1700; however, the computing device is not limited thereto and may include at least one computing device capable of performing computations, including a processor.

Referring to FIG. 13, a method for displaying player information in a sports video according to an embodiment of the present disclosure may include acquiring a captured video of a sports event over a target time interval S1310, acquiring sensor-based locational information for each player S1320, determining corresponding positions in the captured video for the sensor-based locational information S1330, and displaying each player's information at the corresponding positions S1340.

More specifically but not exclusively, as shown in FIG. 13, the computing device may first acquire a captured video of a sports event over a target time interval S1310. Here, the target time interval may be determined, for example, as the period from the start to the end of an official match when the sports event is an official game, or from a predetermined training start time to a training end time when the sports event is a training session. Alternatively, a time interval with arbitrarily set start and end points may be designated as the target time interval for acquiring the sports video.

The captured video of the sports event may be acquired using the camera 1200, as described above in the present disclosure. The camera 1200 may be a single camera or a plurality of cameras; when a plurality of cameras are used, procedures such as stitching, registration, and distortion compensation may be performed between multiple images. The computing device may acquire the captured video of the sports event by receiving a video of a sports event captured by the camera 1200 through wired or wireless communication means.

Referring again to FIG. 13, the computing device may acquire sensor-based locational information for each player participating in the sports event over the target time interval S1320. Here, according to one aspect, the sensor-based locational information may be obtained based on the Global Navigation Satellite System (GNSS) but is not limited thereto.

As previously described in the embodiment of the present disclosure, in one aspect, sensor-based locational information for each player participating in a sports event over a target time interval may be obtained by the sensing platform 1100, more specifically, by a sensor-based platform. An attachable device such as the sensor device 1300 may be attached to each of the plurality of players, which allows the acquisition of sensor-based locational information for each player.

Referring again to FIG. 13, the computing device may determine the corresponding position within the captured video for the acquired sensor-based locational information of each player S1330. In other words, within the captured video of the sports event, it is determined where the information for a particular player has to be displayed. To ensure that information on a specific player is displayed at the position corresponding to the player in the video, a matching process is required between information on each player and their respective positions in the video.

According to one embodiment of the present disclosure, to determine the corresponding position of each player within a sports video, the process of determining the corresponding position of each player in the sports video may involve receiving predetermined information from a user of the computing device and performing computations based on the input information. For example, the locations of the pitch corners within the video may be directly input by the user, and the corresponding locations of at least part of players among a plurality of players at particular time points may be input directly by the user. Based on the input information, the computing device may determine the corresponding positions of the remaining players at other time points in the sports video.

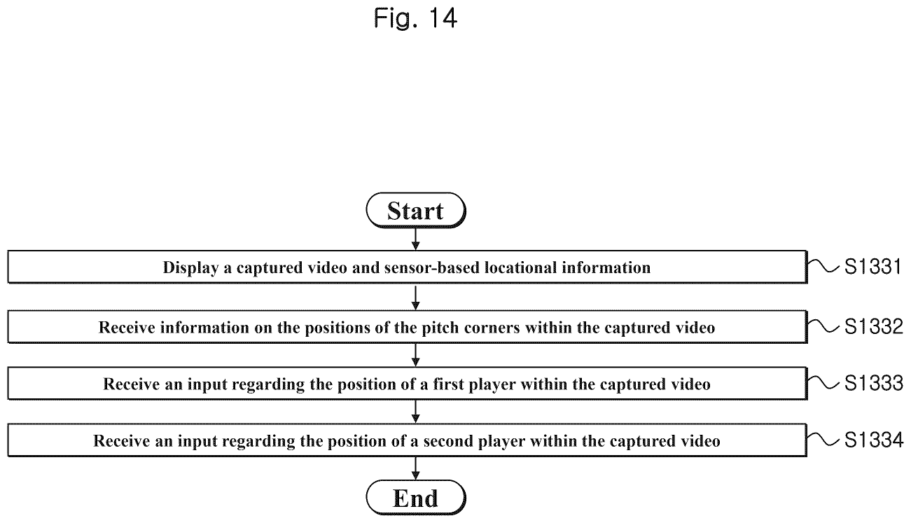

FIG. 14 is a detailed flowchart illustrating the determining of the corresponding position of FIG. 13. With reference to FIG. 14, the corresponding position determination process for each player in the sports video will be described in more detail. As shown in FIG. 14, to determine the corresponding positions, the computing device may first display the captured video and at least a portion of the sensor-based locational information S1331.

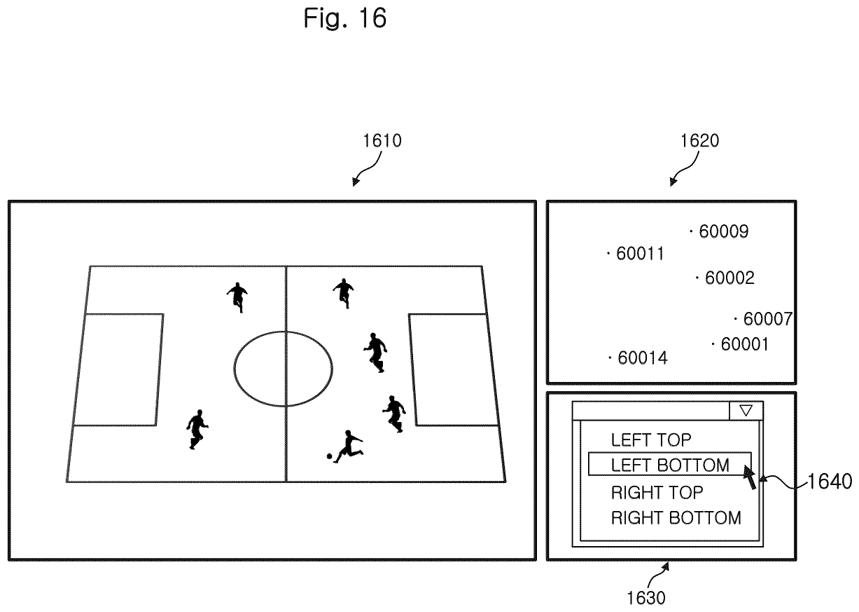

In this regard, FIG. 16 is an exemplary diagram for a display screen of a captured video and sensor-based locational information according to one embodiment of the present disclosure. As shown in FIG. 16, the display of the computing device or a user terminal connected to the computing device may include a sports video display area 1610, a sensor-based locational information display area 1620, and an input item selection area 1630.

In the sports video display area 1610, at least a portion of the captured video of the sports event may be displayed. For example, the displayed sports video may be, but not limited to, a tactical view video, a sports video in the planar view of the field, or any other different view of the sports video.

In the sensor-based locational information display area 1620, sensor-based locational information for at least part of the plurality of players previously acquired may be displayed. As shown in FIG. 16, the sensor-based locational information may include, for example, the identification number of the corresponding sensor device and the acquired locational information. More specifically but not exclusively, the displayed sensor-based locational information may include at least one of the relative positional relationship of each sensor-based locational information with respect to the representative value of a plurality of sensor-based locational information or identification information of the sensor device corresponding to each sensor-based locational information. In other words, the plurality of sensor devices may be, for example, GPS sensors, and may acquire the respective locational values based on the global coordinate system. The representative value (e.g., the average value) of the coordinate values of the plurality of sensor devices acquired based on the global coordinate system may be set to be positioned at the center of the sensor-based locational information display area 1620, and the identification information (e.g., 60009, 60002) and an indication representing the measured locational value of each sensor device may be displayed at appropriate positions within the sensor-based locational information display area 1620 according to the relative positional relationships of position values of the sensor devices based on the global coordinate system with respect to the representative value. Accordingly, as shown in FIG. 16, users may recognize which of the plurality of players appearing in the sports video display area 1610 correspond to which of the identification numbers of the plurality of sensor devices and their respective locational values displayed in the sensor-based locational information display area 1620. Therefore, the user may determine which measured positional value of a sensor device with specific identification information corresponds to a particular player appearing at a specific time point or in a specific frame of a sports video, as shown in FIG. 16.

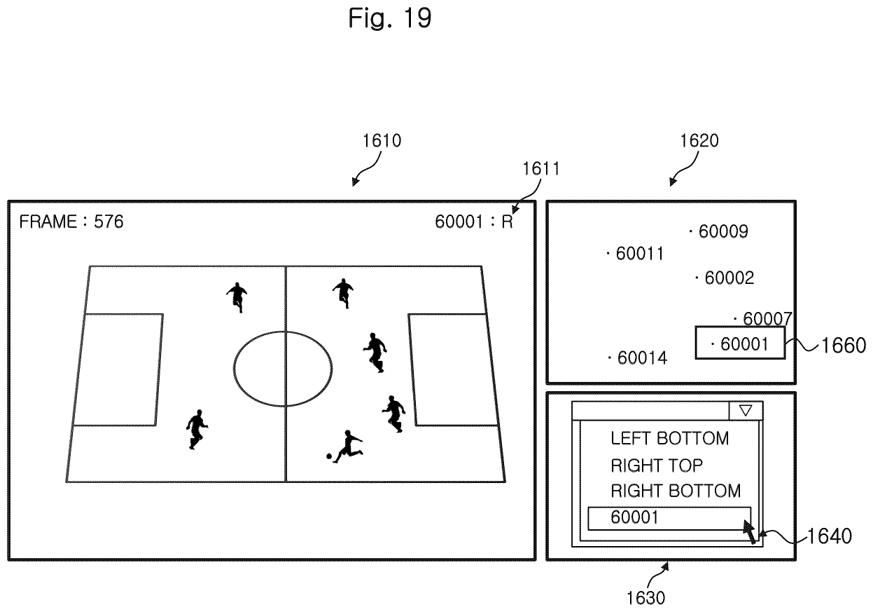

According to one aspect, the sensor-based locational information display area 1620 may display a location input request message for, for example, a first player or a second player. As will be described later in the present disclosure, the user may input the locational information of a specific player within the video, and the sensor-based locational information display area 1620 may show which player's locational information should be input within the video. In this regard, as shown in FIG. 19, to receive from the user the location of a player corresponding to the measured value of the sensor device identification number 60001, a location input request message 1660 for the specific player may be displayed in the sensor-based locational information display area 1620 by highlighting the identification number 60001. However, it should be noted that the method of displaying the location input request message is not limited to the highlighting method, and any means or form for instructing the user to input the position of a specific player within the video may be provided to the user.

Meanwhile, the input item selection area 1630 may display an interface for selecting the type of information the user wants to input. As shown in FIG. 16, for example, in the step of receiving information on the location of a corner of the pitch within a sports video from the user, an interface may be displayed to allow the user to select which corner's position to input based on a pointer 1640. For example, if the user wants to input the locational information of the left-bottom corner (LEFT BOTTOM) within the video, the user may position the pointer 1640 in the “LEFT BOTTOM” area and click to enter the input mode for the left-bottom corner's position within the video. As shown in FIG. 19, in the mode for receiving information on a specific player's position within the sports video, the user may respond to the location input request message 1660 of the corresponding player with the identification number 60001 and enter the position input mode for the position of the player corresponding to the identification number 60001 by positioning the pointer 1640 on the input interface for identification number 60001 in the input item selection area 1630 and clicking the input interface.

Referring again to FIG. 14, the determining of the corresponding position will be further described. For example, as shown in FIG. 16, after displaying at least part of the captured video and the sensor-based locational information S1331, the computing device may receive, from the user, information on the positions of the pitch corners within the captured video S1332.

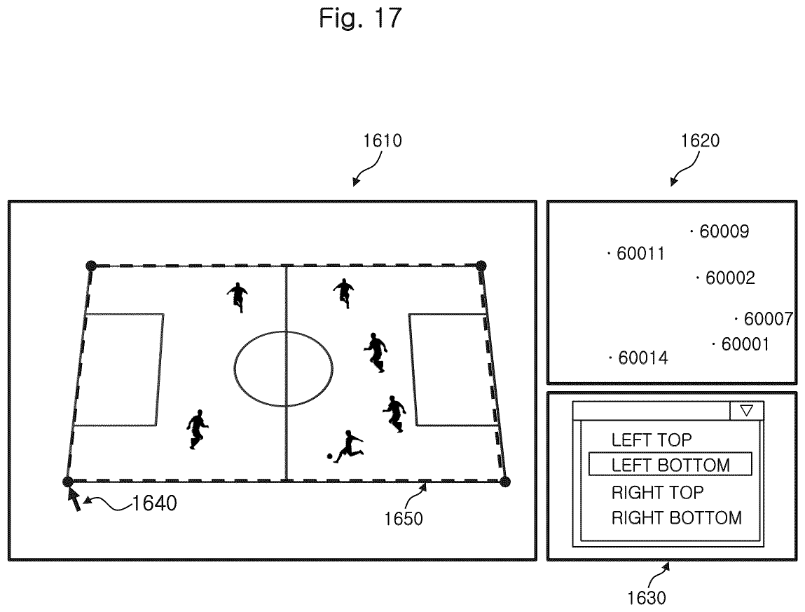

FIG. 17 is an exemplary diagram of a screen for inputting pitch corners by a user. As shown in FIG. 17, to input the positions of pitch corners within the captured video, the user may select one among pitch corners and input the position of the selected pitch corner within captured video into the input item selection area 1630. For example, as shown in FIG. 17, to input the position of the left bottom corner (LEFT BOTTOM) within the captured video, the user may click the LEFT BOTTOM area in the input item selection area 1630 and then click the lower-left pitch corner within the sports video displayed in the sports video display area 1610 using the pointer 1640. Therefore, the user may input the position of the lower-left pitch corner within the sports video into the computing device. In one aspect, for example, a video area with a predetermined size indicated by the pointer 1640 may be magnified and displayed to facilitate the selection of a specific point within the sports video.

Once the position input for the remaining pitch corners in the sports video is sequentially performed, information on the boundary 1650 of the pitch in the video may be obtained. Based on the information on at least one of the pitch boundary or a plurality of pitch corners, conversion between the pixel coordinate system and the pitch coordinate system may be performed. More specifically, in one aspect, the information on the locations of the pitch corners within the captured video may be used for conversion between the pixel coordinate system, which represents positions in the captured video, and the pitch coordinate system, which represents positions within the pitch in which a sports event takes place. In other words, the pixel coordinate system may represent the position of a specific pixel within the video; for example, if the resolution of the video is 1080×768, the position of a specific pixel may be represented as a position value in the pixel coordinate system, such as (872, 111). Also, if the size of the pitch where the sports event is performed is, for example, 80 m×45 m, the position of a specific player within the pitch may be represented as a position value in the pitch coordinate system, such as (45, 8). In each coordinate system, the origin may be set, for example, at the top-left corner; however, the origin is not limited thereto, and any corner may be selected as the origin to define the coordinate system.

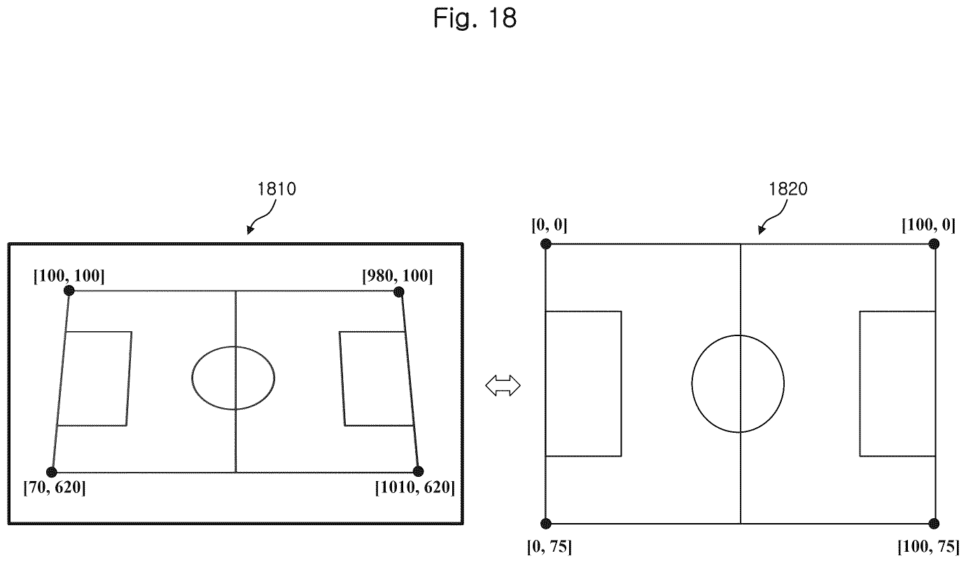

FIG. 18 illustrates conversion between pixel coordinate system and pitch coordinate system. As shown in FIG. 18, for example, in the pixel coordinate system 1810, a plurality of corners may have position values of top-left (100, 100), bottom-left (70, 620), top-right (980, 100), and bottom-right (1010, 620) corners, while, in the pitch coordinate system 1820, a plurality of the corresponding corners may have position values of top-left (0, 0), bottom-left (0, 75), top-right (100, 0), and bottom-right (100, 75) corners; however, it should be noted that the position values are not limited to the specific examples.

Since the position values in the pitch coordinate system and pixel coordinate system may be acquired for a plurality of corners, conversion between the position values in the pitch coordinate system and the position values in the pixel coordinate system may be perform through computational operations. For example, a conversion matrix may be set up for conversion between the two coordinate systems, or conversion between the pixel coordinates and the pitch coordinates of a specific point may be performed based on interpolation or extrapolation for a plurality of corners.

In one aspect, the sports video may be displayed after being transformed to a view acquired through image processing (e.g., tactical view) and a different view (e.g., top view). Also, based on the user's control input, the sports video may be displayed after being transformed to a viewpoint desired by the user. For example, an area of interest may change according to the progress of the sports event or according to the purpose of video analysis. Image processing may be performed to provide a sports video from a viewpoint desired by the user based on the user's viewpoint transformation input. Here, for example, the top view may display the positions of one or more players based on the pitch coordinate system and may serve as a reference for transformations between different views. However, the reference video is not necessarily limited to the video based on the pitch coordinate system, and any other coordinate system, including the spherical coordinate system expressing the pitch to have a specific distance and angle relative to a virtual center, may be used as the reference coordinate system.

Referring again to FIG. 14, the computing device may receive an input from the user regarding the position of a first player within the captured video S1333.

FIG. 19 is an example of a position input request screen for a first player. As shown in FIG. 19, the sports video display area 1610 may display a sports video of a specific frame, such as frame 576. Here, for example, an input request message 1660 for the locational information of the first player may be displayed on the sensor-based locational information display area 1620. In the example of FIG. 19, the first player may correspond to a player corresponding to the sensor device with an identification number 60001.

The user may respond to the input request message 1660 for the locational information of the first player and select inputting position information for the first player (identification number 60001) in the input item selection area 1630. For example, by clicking the area indicating inputting of the first player using a pointer 1640, the user may enter the position input mode for the first player.

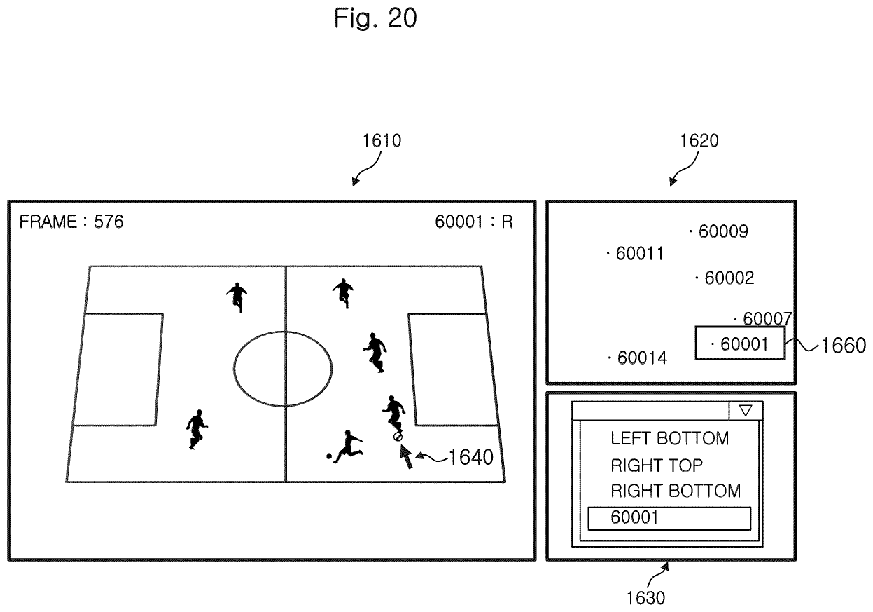

FIG. 20 is an example of a position input screen for the first player by the user. As shown in FIG. 20, by selecting and clicking the position of the player corresponding to identification number 60001 within the sports video using the pointer 1640, the user may input the first player's position within the sports video into the computing device. Here, in one aspect, the position of a specific player may be configured to be input by clicking, but not necessarily limited to, the center of an area below the player's feet. For example, in the player position input mode, a guide message may be output instructing the user to click the center of an area below the corresponding player's feet.

Referring back to FIG. 14, the computing device may receive, from the user, information on the position of a second player within the captured video S1334.

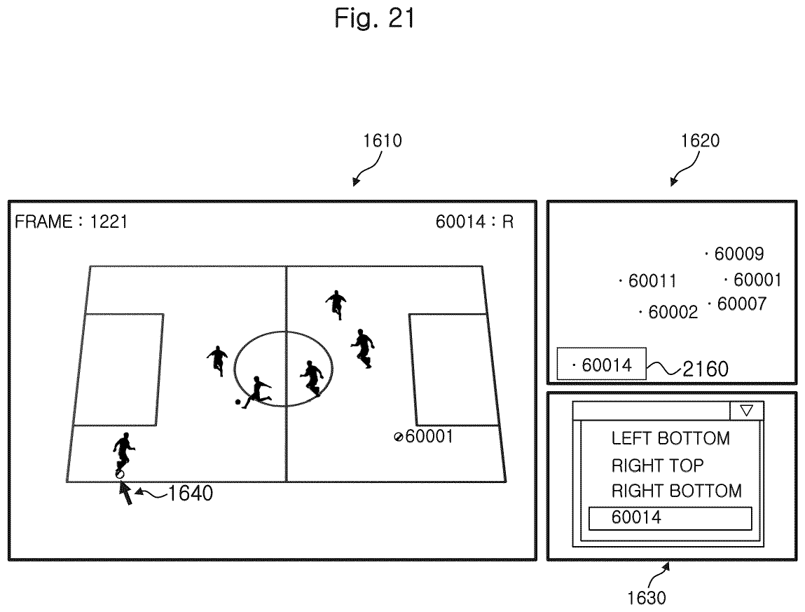

In this regard, FIG. 21 is an example of a position input screen for the second player by the user.

Similar to the position input request screen for the first player, the sports video display area 1610 may display a sports video at a specific frame, such as frame 1221. Here, for example, a position input request message 2160 for the second player may be displayed in the sensor-based locational information display area 1620. In the example of FIG. 21, the second player may be the player corresponding to a sensor device with an identification number 60014.

The user may respond to the input request message 2160 for the locational information of the second player and select inputting position information for the second player (identification number 60014) in the input item selection area 1630. For example, by clicking the area indicating inputting of the second player using a pointer 1640, the user may enter the position input mode for the second player.

As shown in FIG. 21, by selecting and clicking the position of the player corresponding to identification number 60014 within the sports video using the pointer 1640, the user may input the second player's position within the sports video into the computing device. Here, in one aspect, the position of a specific player may be configured to be input by clicking, but not necessarily limited to, the center of an area below the player's feet. For example, in the player position input mode, a guide message may be output instructing the user to click the center of an area below the corresponding player's feet.

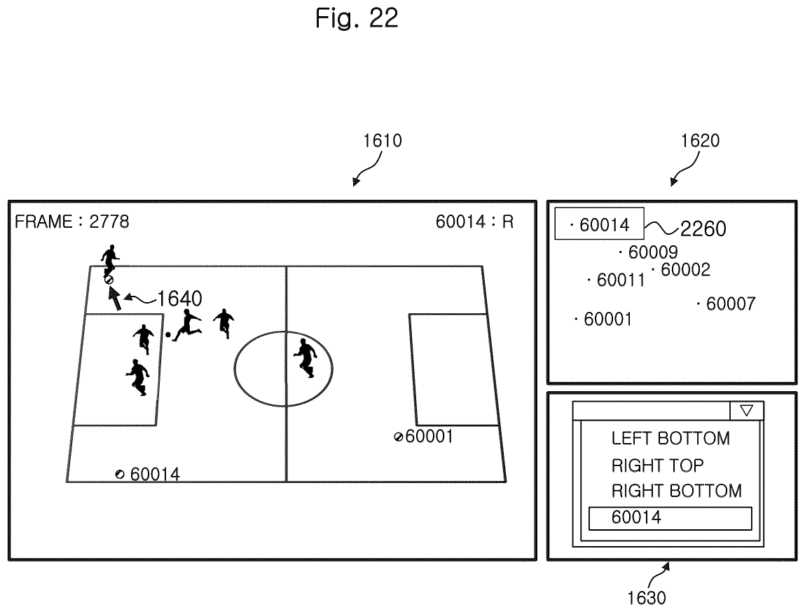

Meanwhile, FIG. 22 is an example of a position input screen for the third player by the user.

Similar to the position input request screen for the first or second player, the sports video display area 1610 may display a sports video at a specific frame, such as frame 2778. Here, for example, a position input request message 2260 for the third player may be displayed in the sensor-based locational information display area 1620. In the example of FIG. 22, the third player may be the player corresponding to a sensor device with an identification number 60014.

The user may respond to the input request message 2260 for the locational information of the third player and select inputting position information for the third player (identification number 60014) in the input item selection area 1630. For example, by clicking the area indicating inputting of the third player using a pointer 1640, the user may enter the position input mode for the third player.

As shown in FIG. 22, by selecting and clicking the position of the player corresponding to identification number 60014 within the sports video using the pointer 1640, the user may input the third player's position within the sports video into the computing device. Here, in one aspect, the position of a specific player may be configured to be input by clicking, but not necessarily limited to, the center of an area below the player's feet. For example, in the player position input mode, a guide message may be output instructing the user to click the center of an area below the corresponding player's feet.

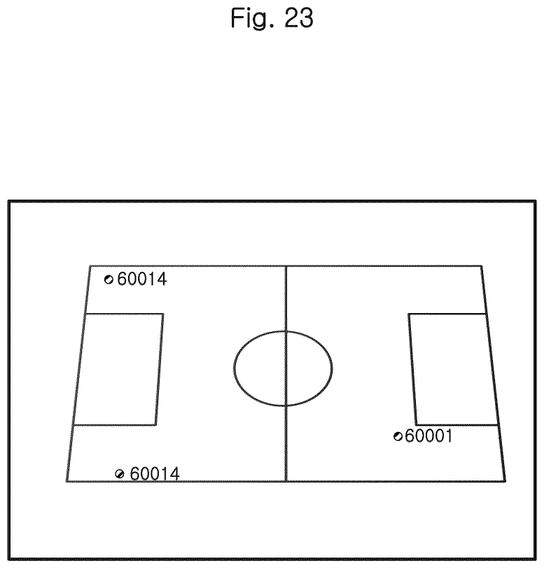

FIG. 23 is an example of a position input result for a plurality of players. As shown in FIG. 23, the positions of the first, second, and third players in the image may be stored together with the sensor-based locational information at the corresponding time point acquired by the sensor device for the corresponding player.

In one aspect, at least part of the first, second, or third player may be the players exhibiting the largest mutual separation distance among the plurality of players included in the captured video. For example, positions of a plurality of players corresponding to at least one of a plurality of time points within the captured video may be determined as the first, second, or third player; the selected players may be determined as the players exhibiting the largest mutual separation; more specifically but not exclusively, the players may be determined based on, but not limited to, a convex hull algorithm. By selecting players separated as far apart as possible from each other as reference players, the accuracy of determining the positions of the remaining players within the sports video, whose positions within the sports video have not been input by the user, may be improved. The accuracy improvement may be attributed to the fact that interpolation-based position determination is more accurate than the extrapolation-based approach.

According to one aspect, the procedure for receiving information on the positions of at least part of the first player, the second player, or the third player within the captured video may be performed for different frames among a plurality of frames included in the captured video. In other words, for example, as shown in FIG. 21, the position of the first player in the input video may be entered in frame 576, the position of the second player in the input video may be entered in frame 1221 as shown in FIG. 22, and the position of the third player in the input video may be entered in frame 2778 as shown in FIG. 23.

Furthermore, according to one aspect, the information on the positions of at least part of the first player, the second player, or the third player within the captured video may be the position information of a single player in different frames. For example, as shown in FIGS. 21 and 22, positions of both the second player and the third player within the sports video may be configured to be input based on the sensor-based locational information acquired by the sensor device with identification number 60014.

According to one embodiment of the present disclosure, receiving the position of the first player, the second player, or the third player within the sports video may not necessarily mean acquiring the position of a specific sensor device with a particular identification number in the sports video but may rather involve acquiring a pair consisting of a specific sensor-based locational information at a particular time point and the position corresponding to the sensor-based locational information within the sports video. Accordingly, regardless of whether positions within the video are entered from a single or a plurality of frames, or whether positions within the video corresponding to a single or a plurality of sensor devices, a plurality of pairs of (sensor-based locational information, position information within the video) may be acquired; however, as previously described, the reference players may be determined so that the plurality of locational information pairs are separated as far apart as possible. According to one aspect, this determination of the reference players may be automatically computed by a computing device, prompting the user to enter the position of a particular player in a specific frame or allowing the user to select players who are separated as far apart as possible and enter their corresponding positions within the video.

Meanwhile, according to one embodiment of the present disclosure, the determination of the reference players may be performed in consideration of the accuracy of the corresponding sensor-based locational information. More specifically but not exclusively, the computing device may be configured to receive information on the positions of at least one of the first player, the second player, or the third player within the captured video in response to the determination that the sensor-based locational information of at least one of the first player, the second player, or the third player has been obtained in the RTK-GPS mode.

As described above, according to one embodiment of the present disclosure, to improve the accuracy of sensor-based locational information, an enhanced sensor-based positioning method or equipment compared to conventional GPS may be applied; for example, RTK-GPS may be used. Even when RTK-GPS equipment is applied, there may be situations where positioning is not performed in the RTK-GPS mode at a specific time point or location. Whether positioning has been performed based on the RTK may be included as information on the positioning mode in the GPS signal; for example, as shown in FIG. 19, information 1611 indicating that a particular sensor device, such as the sensor device with identification number 60001, has performed positioning in the RTK-GPS mode at the corresponding frame time may be displayed in the form of an indicator, such as the letter “R.” According to one aspect of the present disclosure, by receiving the position within the corresponding sports video only for the sensor-based positioning information measured in the RTK mode, the accuracy of determining the positions of the remaining players within the sports video may be improved.

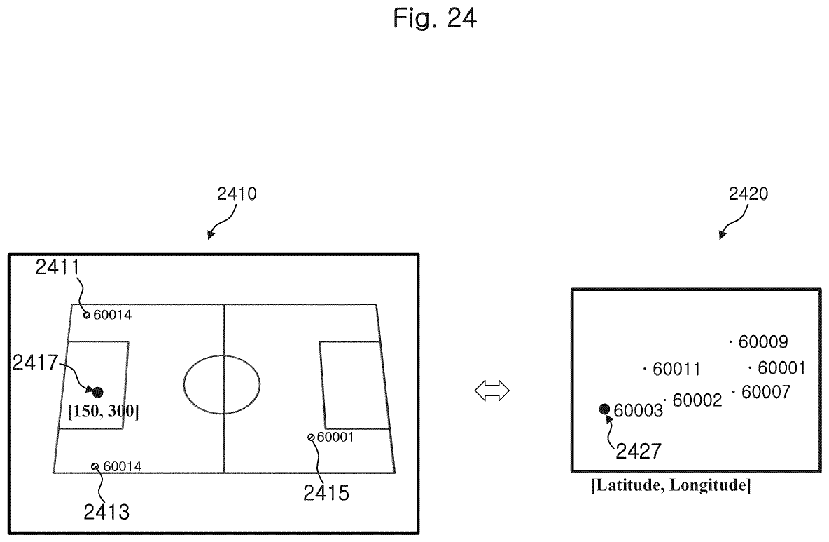

According to one embodiment of the present disclosure, the information on the position of the first player within the captured video and the information on the position of the second player within the captured video may be used for conversion between the global coordinate system used by the sensor-based locational information and the image coordinate system representing positions within the captured video. In this regard, FIG. 24 illustrates conversion between pixel coordinate system and global coordinate system.

More specifically but not exhaustively, as shown in FIG. 24, the information on the position of the first player within the captured video 2415, the information on the position of the second player within the captured video 2413, or the information on the position of the third player within the captured video 2411 may be paired with their corresponding sensor-based locational information. Based on the pairs of position information within the video and sensor-based locational information, conversion between the image coordinate system 2410 and the global coordinate system 2420 may be performed. For example, based on the information on the position of the first player within the captured video 2415, the information on the position of the second player within the captured video 2413, or the information on the position of the third player within the captured video 2411, and their corresponding sensor-based locational information values, the corresponding position within the captured video 2417 for a first position 2427 among the sensor-based locational information may be determined.

In other words, since position values within a plurality of images and their corresponding position values in the global coordinate system may be acquired, conversion between the position values in the global coordinate system and the image coordinate system may be performed through computational operations. For example, a transformation matrix for conversion between the two coordinate systems may be established, or conversion between specific points in the global coordinate system and the image coordinate system may be performed based on interpolation or extrapolation for a plurality of corner points.

According to one aspect of the present disclosure, the computing device may perform conversion between the global coordinate system used by the sensor-based locational information and the pitch coordinate system representing positions within the pitch where a sports event is performed, based on at least part of the information on the positions of the pitch corners within the captured video, the position of the first player within the captured video, the position of the second player within the captured video, or the position of the third player within the captured video. As described above, for example, conversion between the image coordinate system and the pitch coordinate system may be performed based on the information on the pitch corners, and conversion between the image coordinate system and the global coordinate system may be performed based on the pairs consisting of the positions of a plurality of players within the video and the corresponding positions in the global coordinate system; accordingly, when needed, conversion between specific coordinate systems among the pitch coordinate system, the image coordinate system, and the global coordinate system may be performed.

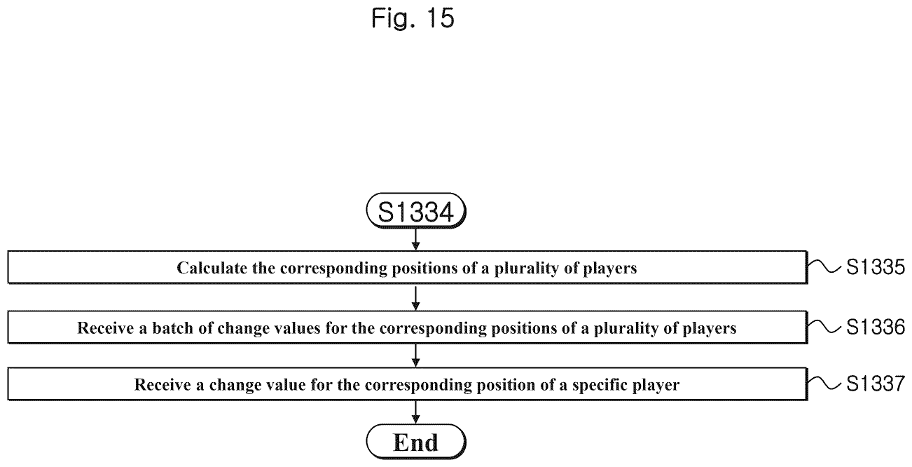

FIG. 15 is a second detailed flowchart illustrating the determining of the corresponding position of FIG. 13.

As shown in FIG. 15, according to one aspect of the present disclosure, to determine the corresponding positions within a captured video for sensor-based locational information (S1330 of FIG. 13), the computing device may calculate the corresponding positions of a plurality of players based on the information on the positions of the pitch corners, a first player, and a second player within the captured video S1335 after receiving the information on the positions of the first player and the second player within the captured video from the user (S1333 to S1334 of FIG. 14). In other words, for the information of a plurality of players included in the acquired sensor-based locational information, corresponding positions within the sports video may be calculated. The corresponding positions may be determined for each time point or frame and for each piece of a plurality of sensor-based locational information.

The computing device may display information for each player at the calculated corresponding position. Based on the display, a correction procedure for the corresponding positions may be initiated.

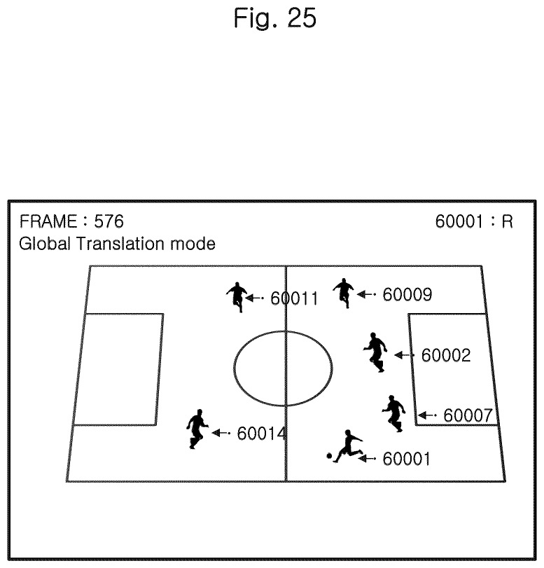

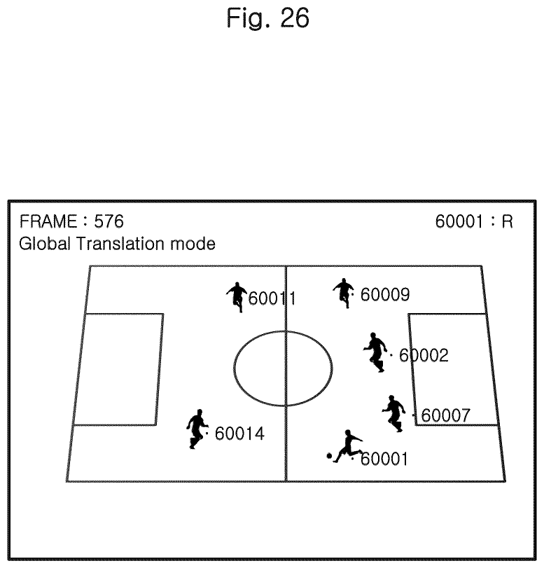

As shown in FIG. 15, according to one embodiment of the present disclosure, the computing device may be configured to receive a batch of change values for the corresponding positions of a plurality of players from the user S1336. In this regard, FIG. 25 illustrates a procedure for receiving a batch of change values for the corresponding positions of a plurality of players from the user, and FIG. 26 shows an information display state according to the batch change result of FIG. 25.

As shown in FIG. 25, even when GPS or RTK-GPS is employed, an error may occur between the position of a player within the video and displayed player information to reveal a specific overall bias. Such errors may arise, for example, from the inherent bias in the GPS positioning mechanism. In another aspect, a separate RTK device may be provided to implement RTK-GPS based positioning; if there is an error in the positioning configuration of the RTK antenna itself, the measured sensor-based locational information may contain an error exhibiting a predetermined tendency.

According to one embodiment of the present disclosure, as illustrated by the arrows in FIG. 25, the computing device may change the calculated positions corresponding to a plurality of the respective players in batches. For example, the computing device may receive a batch of change values for the corresponding positions of a plurality of players from the user and shift all corresponding positions according to the received values. FIG. 25 illustrates an example of receiving an input to shift the corresponding positions of all pieces of player information to the left within the display. Accordingly, as shown in FIG. 26, the player information may be displayed at a more accurate position within the sports video.

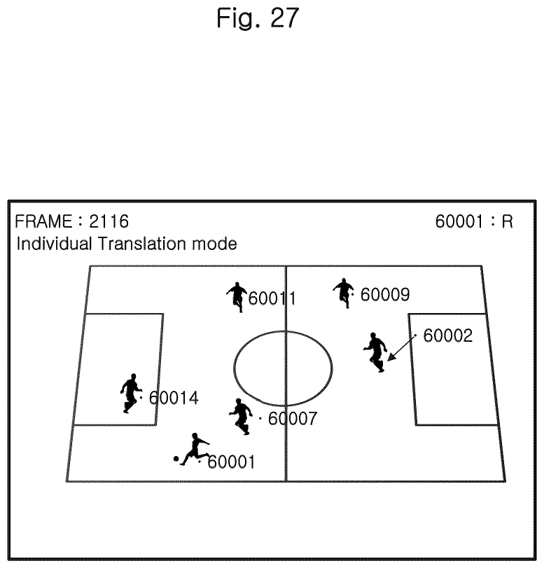

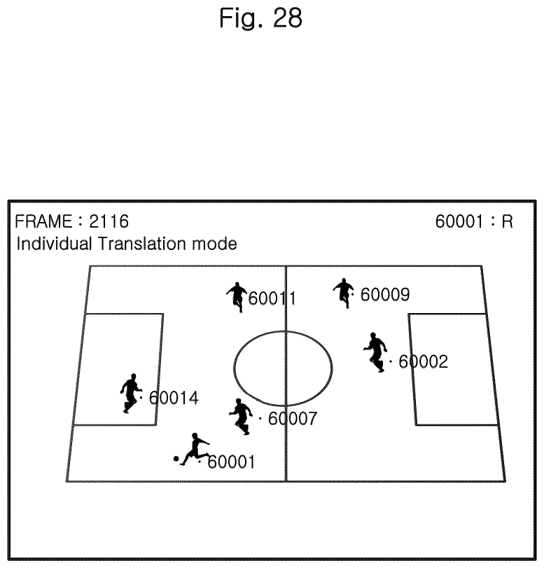

Meanwhile, as shown in FIG. 15, according to one embodiment of the present disclosure, after receiving a batch of change values from the user, the computing device may be configured to receive a change value for the corresponding position of a specific player among a plurality of players S1337. In this regard, FIG. 27 illustrates of a procedure for receiving an individual change value for the corresponding position of a specific player among a plurality of players from the user, and FIG. 28 shows an information display state according to the individual change result of FIG. 27.

As shown in FIG. 27, there may be cases where the information of a particular player (e.g., a player corresponding to the sensor device with identification number 60002) is displayed at an incorrect position within a sports video compared to the information of other players. The above case may occur due to the measurement environment at the time of sensor-based positioning but is not necessarily limited to the specific situation. For the corresponding positions of individual players, the computing device may be configured to receive individual position change values from the user and change the corresponding positions. For example, as shown in FIG. 27, the computing device may receive an input from the user to shift the corresponding position of the player with identification number 60002 in the 7 o'clock direction, and the corresponding position may be changed accordingly. As a result, as shown in FIG. 28, the player information may be displayed at a more accurate position.

Referring again to FIG. 13, the computing device may display the information of each player at the corresponding position S1340. In other words, as described in the present disclosure, the corresponding positions within the sports video for a plurality of pieces of sensor-based locational information may be determined, and the respective pieces of player information may be displayed at the determined positions. Accordingly, as illustrated in FIG. 11, a sports video with integrated player information may be provided to the user.

Meanwhile, regarding improving the accuracy of corresponding positions within the sports video, a synchronization problem between the captured video and the sensor-based locational information may be considered. Suppose the sensor-based locational information is highly accurate; however, if a mismatch occurs between the timestamp of the sensor-based locational information and the corresponding frame of the sports video, an inevitable error may occur between the actual position of the player within the sports video and the corresponding position based on the sensor-based locational information.

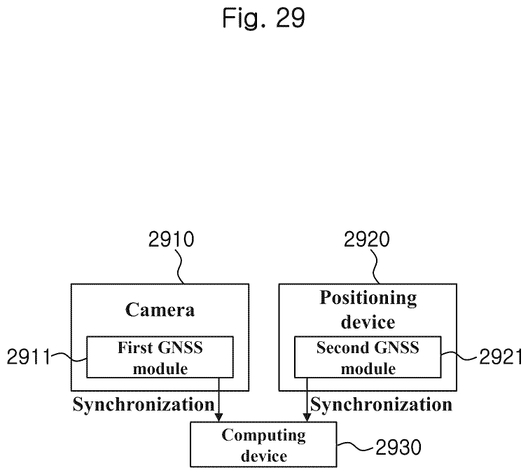

FIG. 29 is a block diagram showing a GNSS module configuration for time synchronization between a captured video and sensor-based locational information. As shown in FIG. 29, according to one embodiment of the present disclosure, the captured video for a sports event may be recorded by the camera 2910 equipped with a first GNSS module 2911, while the sensor-based locational information may be determined using a positioning device 2920 that includes a second GNSS module 2921 of the same type as the first GNSS module. In other words, the camera 2910 used to capture the sports event and the positioning device 2920 used to acquire sensor-based locational information may be equipped with the same type of GNSS module. These GNSS modules of the same type may include timestamps in the same format; for example, information on the UTC time may be provided. Consequently, the acquisition time of each frame in the video captured through the camera 2910 may be recorded based on the UTC time. Also, the acquisition time may also be recorded in the sensor-based locational information based on the UTC time.

According to one aspect, the computing device 2930 may be configured to match each frame of a captured video with the acquisition time of sensor-based locational information based on the time information of the first GNSS module 2911 and the second GNSS module 2921. Therefore, time synchronization between each frame of the sports video and sensor-based locational information is achieved, and position correspondence between the video and the sensor-based locational information may be improved.

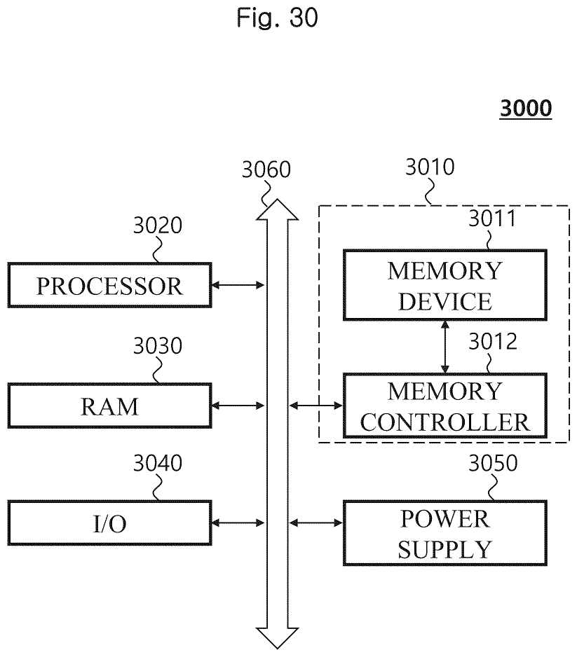

FIG. 30 is a block diagram showing an exemplary configuration of a computing system in which a method according to one embodiment of the present disclosure may be performed.

Referring to FIG. 30, the computing system 3000 may include flash storage 3010, a processor 3020, RAM 3030, an input/output device 3040, and a power supply 3050. Also, flash storage 3010 may include a memory device 3011 and a memory controller 3012. Meanwhile, although not shown in FIG. 30, the computing system 3000 may further include ports that enable communication with video cards, sound cards, memory cards, USB devices, or other electronic devices.

The computing system 3000 may be implemented as a personal computer or a portable electronic device such as a laptop computer, a mobile phone, a personal digital assistant (PDA), and a camera.

The processor 3020 may perform specific calculations or tasks. Depending on the embodiments, the processor 3020 may be a microprocessor or a central processing unit (CPU). The processor 3020 may communicate with the RAM 3030, the input/output device 3040, and the flash storage 3010 via a bus 3060, which may include an address bus, a control bus, and a data bus.

According to one embodiment, the processor 3020 may also be connected to an expansion bus such as the Peripheral Component Interconnect (PCI) bus.

The RAM 3030 may store data required for the operation of computing system 3000. For example, any type of random access memory, including DRAM, mobile DRAM, SRAM, PRAM, FRAM, MRAM, and RRAM, may be used as RAM 3030.

The input/output device 3040 may include input means such as a keyboard, a keypad, and a mouse; and output means such as a printer and a display. The power supply 3050 may provide the operating voltage necessary for the operation of the computing system 3000.

The method according to the present disclosure described above may be implemented as computer-readable code stored on a computer-readable recording medium. The computer-readable recording medium may include any type of recording medium that stores data readable by a computer system. Examples include a read-only memory (ROM), a random access memory (RAM), a magnetic tape, a magnetic disk, flash memory, and an optical data storage device. Also, the computer-readable recording medium may be distributed across computer systems connected via a computer network and stored and executed in a distributed manner.

In this document, the present disclosure has been described with reference to appended drawings and embodiments, but the technical scope of the present disclosure is not limited to the drawings or embodiments. Rather, it should be understood by those skilled in the art to which the present disclosure belongs that the present disclosure may be modified or changed in various ways without departing from the technical principles and scope of the present disclosure disclosed by the appended claims below.

More specifically, the characteristic features described above may be executed by a digital electronic circuit, computer hardware, firmware, or a combination thereof. The characteristic features may, for example, be executed by a computer program product implemented within a storage apparatus of a machine-readable storage device so that they may be executed by a programmable processor. Moreover, the characteristic features may be executed by a programmable processor which executes a program of instructions for performing functions of the aforementioned embodiments as they are operated based on the input data to produce an output. The characteristic features described above may be executed within one or more computer programs which may be executed on a programmable system including at least one programmable processor, at least one input device, and at least one output device, which are combined to receive data and instructions from a data storage system and to transmit data and instructions to the data storage system. A computer program includes a set of instructions which may be used directly or indirectly within the computer to perform a specific operation with respect to a predetermined result. The computer program may be written by any one of programming languages including compiled or interpreted languages and may be used in any other form including a module, an element, a subroutine, another appropriate unit to be used in a different computing environment, or a program which may be manipulated independently.

Processors appropriate for executing a program of instructions include, for example, both of general-purpose and special-purpose microprocessors, single processor, or multi-processors of a different type of computer. Also, storage devices appropriate for implementing computer program instructions and data which implement the characteristic features described above include all kinds of non-volatile storage devices: for example, semiconductor memory devices such as EPROM, EEPROM, and flash memory devices; internal hard disks; magnetic devices such as removable disks; optical magnetic disks; CD-ROM; and DVD-ROM disks. The processor and memory may be integrated within application-specific integrated circuits (ASICs) or added by the ASICs.

Although the present disclosure is described based on a series of functional blocks, the present disclosure is not limited to the embodiments described above and the appended drawings; rather, it should be clearly understood by those skilled in the art to which the present disclosure belongs that various substitutions, modifications, and variations of the present disclosure may be made without departing from the technical principles and scope of the present disclosure.

A combination of the aforementioned embodiments is not limited to the embodiments described above, but depending on implementation and/or needs, not only the aforementioned embodiments but also a combination of various other forms may be provided.

In the exemplary system described above, methods are described according to a flow diagram by using a series of steps and blocks. However, the present disclosure is not limited to a specific order of the steps, and some steps may be performed with different steps and in a different order from those described above or simultaneously. Also, it should be understood by those skilled in the art that the steps shown in the flow diagram are not exclusive, other steps may be further included, or one or more steps of the flow diagram may be deleted without influencing the technical scope of the present disclosure.

The embodiments described above include examples of various aspects. Although it is not possible to describe all the possible combinations to illustrate the various aspects, it would be understood by those skilled in the corresponding technical field that various other combinations are possible. Therefore, it may be regarded that the present disclosure includes all of the other substitutions, modifications, and changes belonging to the technical scope defined by the appended claims.

What is claimed is:

1. A method for displaying player information on a sports video, performed by a computing device, the method comprising:
acquiring a captured video for a sports event over a target time interval;
acquiring sensor-based locational information over the target time interval for each of the players participating in the sports event;
determining the corresponding position in the captured video corresponding to the sensor-based locational information for each of the players; and
displaying information on each of the players at each of the corresponding positions.

2. The method of claim 1, wherein the sensor-based locational information is acquired based on Global Navigation Satellite System (GNSS).

3. The method of claim 1, wherein the player information includes at least one of personal information of the player; sensor-based locational information of the player; speed of the player; and trajectory of the player over a predetermined time interval.

4. The method of claim 1, wherein the determining of the corresponding position includes:
displaying at least part of the captured video and the sensor-based locational information;
receiving information on the positions of pitch corners within the captured video from a user;
receiving information on the position of a first player within the captured video from the user; and
receiving information on the position of a second player within the captured video from the user.

5. The method of claim 4, wherein the first player and the second player correspond to the players, among a plurality of players included in the captured video, who are separated from each other by the greatest distance.

6. The method of claim 4, wherein the receiving of the locational information of the first player in the captured video and the receiving of the locational information of the second player in the captured video are performed on different frames among a plurality of frames included in the captured video.

7. The method of claim 6, wherein the locational information of the first player in the captured video and the locational information of the second player in the captured video correspond to the locational information of a single player in different frames.

8. The method of claim 4, wherein the receiving of the information on the position of the first player in the captured video is performed in response to the determination that sensor-based locational information on the first player has been acquired in the RTK-GPS mode.

9. The method of claim 4, wherein the determining of the corresponding position further includes:
after the receiving of the information on the position of the second player in the captured video from the user,
calculating the corresponding positions of a plurality of players based on information on the positions of the pitch corners, the first player, and the second player in the captured video; and
receiving, from the user, a batch of change values for the calculated corresponding positions of the plurality of players.

10. The method of claim 4, wherein the information on the positions of the pitch corners in the captured video are used for conversion between the pixel coordinate system expressing positions in the captured video and the pitch coordinate system expressing positions in the pitch where a sports event is performed.

11. The method of claim 4, wherein the information on the position of the first player in the captured video and the information on the position of the second player in the captured video are used for conversion between the global coordinate system used by the sensor-based locational information and the pixel coordinate system expressing positions in the captured video.

12. The method of claim 4, wherein the determining of the corresponding position performs conversion between the global coordinate system used by the sensor-based locational information and the pitch coordinate system expressing positions in the pitch where a sports event is performed, based on the information on the positions of the pitch corners in the captured video, information on the positions of the first player in the captured video, and information on the positions of the second player in the captured video.

13. The method of claim 4, wherein the displaying of at least part of the captured video and the sensor-based locational information is configured to display:
a relative positional relationship of sensor-based locational information with respect to a representative value of a plurality of sensor-based locational information;
identification information of a sensor device corresponding to each sensor-based locational information; and
a position input request message for the first player or the second player.

14. The method of claim 5, wherein the first player and the second player are determined based on the distances among a plurality of pieces of sensor-based locational information.

15. The method of claim 9, further including, after the receiving of the batch of change values from the user, receiving a change value for the corresponding position of one of the plurality of players from the user.

16. A device for displaying player information on a sports video comprising:
a processor; and
a memory, wherein the processor is configured to:
acquire a captured video for a sports event over a target time interval;
acquire sensor-based locational information over the target time interval for each of the players participating in the sports event;
determine the corresponding position in the captured video corresponding to the sensor-based locational information for each of the players; and
display information on each of the players at each of the corresponding positions.

17. A computer-readable storage medium including commands executable by a processor, wherein the commands are intended to display player information on a sports video and, by being executed by the processor, are configured to instruct the processor to:
acquire a captured video for a sports event over a target time interval;
acquire sensor-based locational information over the target time interval for each of the players participating in the sports event;
determine the corresponding position in the captured video corresponding to the sensor-based locational information for each of the players; and
display information on each of the players at each of the corresponding positions.
